(19) United States
(12) Patent Application Publication
(10) Pub. No.: US 2005/0261917 A1
(43) Pub. Date: Nov. 24, 2005

(54) Electronic waste management system

(76) Inventor: Danielle Renee Forget Shield, Houston, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/799,826

(22) Filed: Mar. 12, 2004

(51) Int. Cl. G06F 17/60

(52) U.S. Cl. 705/1

(57) ABSTRACT

The present invention provides a system and method for electronically automating the solid waste hauling industry's existing paper system for tracking driver services. In at least one embodiment, the system directs the driver through his daily activities, allowing changes and corrections to customer service data along a route. This information is uploaded and converted to payroll data, customer service information, and invoicing for customers, among other aspects, periodically throughout the route or upon return to a home base after the route. The information that is collected on site and in real time into a unit available to the driver during the route can require specific and traceable entries that improve the accuracy and completeness of the data useful to the waste management system. The automation provides the information collected by a driver independently of additional clerks that heretofore have been used to input this information into a waste management system.

### FIELD OF THE INVENTION

The invention relates to collection and disposal of waste. More specifically, the invention relates to the management of a waste system that handles waste from producer to disposal.

### BACKGROUND OF THE INVENTION

Currently when a roll-off or tractor-trailer waste truck driver leaves a dispatch office to start a route, he is given a paper route sheet to direct his activities for the day. This is the first step in a very long paper trail that eventually leads to the driver getting paid and the customer receiving an invoice, and the waste company collecting on services rendered. The second step in the process begins when the truck driver executes the route assignment, collecting additional pieces of paper (“tickets”) along the route. When the driver hauls a box for a customer, he either hand writes a paper ticket and leaves a copy with the customer to record the activity or has no record that the activity occurred. In some cases, the customer signs the ticket as a record of the haul. The driver must also note information such as the roll-off box number on his route sheet. Without an accurate record, the box can become lost. If the driver is transporting industrial waste, he must also have a manifest, which is a special document authorized and traceable by governmental agencies and created by the generator of the waste. This document must be signed by the generator of the waste and taken by the driver to the landfill. When the driver gets to the landfill, he receives a landfill ticket. By the end of the haul, the driver is responsible for several tickets or other pieces of paper, which must be returned to the dispatch office in good condition. The current system allows for information errors (forgotten information, bad handwriting, language barriers, falsified documents, and so forth) to accumulate through the creation and maintenance of data on these tickets. The tickets contain important information, which places the responsibility on the driver to clearly and legibly collect accurate and complete information.

Further, the waste collection industry often charges for demurrage time, that is, an excessive amount of time that the waste truck driver is at a customer's site to collect the waste. Most customers are allowed a maximum amount of time that the driver spends on their site. Any time logged after this maximum amount of time is billed as demurrage time. The drivers often record the entire time that they are on-site as demurrage time. Existing systems rely on drivers to note how long they spend at a customer site for activities that can be classified as demurrage or billable time. If the driver is paid by the hour or by demurrage time, there is an incentive to overestimate the amount of time at the customer's site.

At the end of the day, these tickets are returned to the central office and used for many purposes including driver payrolls, customer invoicing, and third party payments. Some persons have estimated that the enormous number of tickets generated by waste hauling companies in the United States total about 160,000 tickets per day. Upon arrival at the office, a driver is debriefed to ensure that all paperwork was collected and is in order. The tickets are then routed to the payroll, billing, and box tracking personnel. The various personnel input the data captured on the driver's tickets to a variety of software systems to pay the driver, track the location of equipment, and bill the customer. In a lot of cases the same information is hand keyed into three different systems by three different people. This results in a very labor intensive effort and accuracy can be poor. In some cases, the customer can refuse to sign or sign a false name on the record of receipt and then the customer disclaims the services and refuses to pay. In other cases, a driver can erroneously allege a haul, resulting in an invoice to a customer and an understandable negative reaction by the customer to an improper invoice.

Thus, there remains a need for a more efficient system that substantially reduces or eliminates lost driver tickets, illegible tickets, tickets without appropriate customer signatures and required information. There remains a need for a more efficient system that reduces the need for a billing department to collect, file and make customer copies of the driver tickets to accompany the invoice. There also remains a need to automate the processing of the information to make a seamless and verifiable billing and payment system for the drivers and the customers serviced by the drivers.

### SUMMARY OF THE INVENTION

The present invention provides a system and method for electronically automating the solid waste hauling industry's existing paper system for tracking driver services. In at least one embodiment, the system directs the driver through his daily activities, allowing changes and corrections to customer service data along a route. This information is uploaded and converted to payroll data, customer service information, and invoicing for customers, among other aspects, periodically throughout the route or upon return to a home base after the route. The information that is collected on site and in real time into a unit available to the driver during the route can require specific and traceable entries that improve the accuracy and completeness of the data useful to the waste management system. The automation provides the information collected by a driver independently of additional clerks that heretofore have been used to input this information into a waste management system.

The invention provides a waste management system, comprising: a waste management electronic base system having a memory, processor, an input element, and an output element, the base system adapted to process waste management data for tracking a location of a waste storage unit, billing a customer associated with a waste removal, and paying personnel for services associated with the waste removal; and an electronic portable unit having a memory, processor, an input element, and an output element, the portable unit adapted to allow an operator during a waste removal to use the portable unit and to allow onsite input at a customer facility from preprogrammed queries regarding the waste removal and further being adapted to generate an output of the data to the base system for processing.

The invention also provides a method of managing waste removal, comprising: using a waste management electronic base system having a memory, processor, an input element, and an output element, to process waste management data, comprising tracking a location of a waste storage unit, billing a customer associated with a waste removal, and paying personnel for services associated with the waste removal; and using an electronic portable unit having a memory, processor, an input element, and an output element, to gather onsite data for the base system, comprising allowing an operator to input onsite data at a customer facility into the portable unit from preprogrammed queries regarding the waste removal, and generating an output of the data to the base system for processing.

### BRIEF DESCRIPTION OF THE DRAWINGS

A more particular description of the invention, briefly summarized above, can be realized by reference to the embodiments thereof that are illustrated in the appended drawings and described herein. However, it is to be noted that the appended drawings illustrate only some embodiments of the invention. Therefore, the drawings are not to be considered limiting of its scope, for the invention may admit to other equally effective embodiments.

FIG. 1A is an overall schematic view of one embodiment of the present invention and serves as an index guide for the remaining figures.

FIG. 1 is an overall schematic diagram of one embodiment of the present invention for the reporting, tracking, and output functions.

FIG. 2 is an overall schematic diagram of an interrelationship between customers' sites, hauling company, drivers, and disposal locations.

(FIGS. 3, 6, 7, 20, and 25 are not present to allow the figure numbers to correspond to the numbering established in the index grid of FIG. 1A.)

FIG. 4 is an overall schematic diagram of one embodiment of the present invention regarding possible functions with a database at an office or other location.

FIG. 5 is a schematic diagram of maintenance personnel functions.

FIG. 8 is a schematic diagram of some exemplary features of the driver functions.

FIG. 9 is a schematic diagram of the driver functions interface program and various aspects of adding a new customer site.

FIG. 10 is a schematic diagram that generally relates to reporting functions that are uploaded to the database, shown in FIG. 1.

FIG. 11 is schematic diagram of a portion of the program relating to destinations and tracking of the waste storage unit.

FIG. 12 is a schematic diagram of the portion of the program relating to the tracking of in-plant functions performed by the operator.

FIG. 13 is a schematic diagram of additional features of the customer site functions portion of the program.

FIG. 14 is a schematic diagram of a portion of the route sheet functions and help/forward utility functions.

FIG. 15 is a schematic diagram of a portion of the program related to block functions in the box yard.

FIG. 16 is a schematic diagram of a portion of the program relating to destination site functions for non-landfill destinations.

FIG. 17 is a schematic diagram of a portion of the program relating to customer site functions being completed and going to destination site functions.

FIG. 18 is a schematic diagram relating to customer site plant hauling functions.

FIG. 19 is a schematic diagram of a portion of the program related to box hauls.

FIG. 21 is a schematic diagram of a portion of the program relating to destination transfer station site functions.

FIG. 22 is a schematic diagram of a portion of the program related to destination site functions and customer site functions.

FIG. 23 is a schematic diagram relating to a portion of the program for manifests.

FIG. 24 is a schematic diagram of a portion of the program related to box damage assessments.

FIG. 26 is schematic diagram of a portion of the program relating to delivery of the box, file destination, and a possible pick up of an empty box.

FIG. 27 is a schematic diagram of a portion of the flow chart that relates to decisions after the daily routes are completed.

FIG. 28 is a schematic diagram of a portion of the program relating to transaction receipts and customer payments.

### DETAILED DESCRIPTION OF THE INVENTION

The present invention provides a significant improvement over the prior system in general use by waste haulers. While some specific aspects may be known in other industries, the waste haul industry has not been able to benefit from these aspects for a number of reasons, including a unitized format as provided by the present invention. While the motivation in the waste hauling industry to become more efficient is clearly a goal and the need has been long felt, the tools to accomplish that goal have simply not been evident to this industry.

In general, the basic waste management system allows for the following processes in conjunction with a base unit, a portable unit and programming associated therewith. The system can be altered to accommodate specific needs of a particular hauling operation and the below process is only one exemplary embodiment of the invention.

Routing information is uploaded to the waste management system, through for example, a data port link to a terminal or server unit or, in a wireless setting, through a company's existing radio system or mobile phone system. Most if not all of the information that would be found on a driver's paper route sheet can be loaded into a waste management system unit. The information can be transmitted in a secure format to ensure accuracy and eliminate access by those not on the system.

The driver uses a personal identification number to initiate his tasks for the day. Each transaction made with the waste management system can record a date and time so that activities of the driver can be tracked.

The driver begins his day with a vehicle pre-trip inspection record. When the driver is ready to begin his pre-trip inspection, he initiates that menu item on the waste management system. The waste management system directs the driver through the pre-trip questionnaire and requires acknowledgement of service needs. If vehicle maintenance is required, the driver can obtain a mechanics authorization before leaving with the truck. If a second truck is obtained as a replacement for the initial truck, the waste management system can require the driver to perform a second pre-trip report. Once the driver has completed an approved pre-trip inspection, he can initiate his daily route tasks. The waste management system can maintain the current and previous day's pre and post trip inspections for easy reference. Additional company information and safety paperwork can also be incorporated into the waste management system to fit a customer's specific needs. The company information can include for example, particular instructions from the customer such as a preferred waste site to dispose of the waste.

When the driver is ready to begin his route, the waste management system allows him to view the day's schedule and begin the route when he is ready. Tasks do not have to be performed in order, unless specified by the dispatcher. If allowed, drivers have the option of choosing which customer they will service first.

The driver proceeds to a predetermined stop. The waste management system can navigate the driver through a series of questions to ensure the proper customer specific information is collected. The waste management system generally does not allow a transaction to be completed until all information is collected. If necessary, the driver prints a receipt for the customer or captures a signature. The signature can include a handwritten name of a person or any other identifying mark or signal, whether handwritten or electronic, including scanned codes, magnetic transmitters/receivers, fingerprints, retina scans, and other identifiers, whether of a person or a business entity. The driver has the ability to add services at each stop to capture all information on services provided. The waste management system also has the ability to maintain electronic manifests if they are allowed by the corporate environmental department, a national agency such as the Environmental Protection Agency (EPA), or various states environmental agencies.

When the driver leaves a customer site, he can proceed to a variety of locations. If the driver is headed to a landfill, the waste management system allows for customer specific instructions at the landfill. If the customer specific task requires a trip to the landfill, the waste management system in one embodiment will not allow the transaction to be finalized until the landfill ticket information is entered into the unit.

Further, regardless of where the driver goes, if he is carrying a box, the location of that box will be tracked until he tells the waste management system where he dropped that specific box. The result is that the location of the box is automatically tracked by the waste management system to show a location and a driver who took the box to that location.

The waste management system can direct the driver throughout the route loop for assignments until all tasks are complete for the day. Additional information can be added manually or automatically to the unit if additional assignments are made throughout the day.

When the driver returns the waste management system to the dispatcher, information that has been collected all day is uploaded to a database system that interacts with the company's existing payroll and billing systems. In a wireless setting, the data could be uploaded throughout the day as the tasks are completed. Data requirements and uses for each of these systems is detailed in the following paragraphs:

Payroll—Drivers can be paid in a variety of ways: hourly, per haul plus demurrage time, per day, or by the cubic yard. The payroll database already includes the driver's names, their personal payroll rates, and on what basis their pay is calculated. Currently a clerk must enter the other information: number of hours, number of hauls, demurrage time, days worked, yards of waste collected, and so forth. The waste management system can collects this information that can be uploaded to automatically calculate the payroll without necessitating a data-entry clerk for at least the bulk of the information. The data format can be altered to meet the needs of the payroll system or outside company providing this service.

Productivity Reports—The information captured by the waste management system can be sorted and presented in a variety of ways. Since the waste management system records the time and date of transactions, this information can be withdrawn from database in a variety of formats to allow for more efficient management. The customer no longer has to rely on the driver to accurately record times for tracking purposes. The recorded information in the waste management system allows a company to efficiently track the number of final hauls, deliveries, and other performance data by each driver and the time it takes to perform these tasks. Statistical information such as hauls per hour, productivity, downtime hours for maintenance, rental boxes, damaged boxes, and so forth can be readily calculated and provided in a report. Revenue information can also be integrated into this system to track revenue per transaction type, per driver, and other measurements.

Invoicing—The information currently entered or verified in most systems includes the account number, dates, times, mileage, landfill used, material disposed of, disposal ticket number, disposal quantity, disposal billing quantity, type of container, final/swap/haul and return/delivery verification. The waste management system will have collected all of this information en route and it can be automatically transferred into the accounting system. Invoices can be generated faster, more accurately, and can be automated. Further, an invoice can be generated at the customer's site, if desired. The backup information for the invoices can also be readily available and can be printed on demand from the waste management system. This improvement contrasts to the current systems in that once a route sheet has been completed by the driver, the information is given to the accounting department to complete the transaction that was initiated by customer service. The accounting clerks must enter information from the drivers' route sheets and later produce an invoice, often inaccurate due to inadequate input.

Box Tracking—Most companies currently have a difficult time tracking the thousands of boxes they own. As described above, lost boxes are not uncommon. The waste management system allows the driver to input the identifier for the particular box that the driver is hauling. In some embodiments, the identifier can be scanned into the waste management system unit if an electronic tracking method is utilized. In other embodiments, the driver can input the box number and location manually. The driver can input this information when the box is picked up and when it is returned or otherwise relocated. This readily available information automatically updates the inventory management system at the end of the day or more periodically in a wireless setting. This enables a hauling company to know where its inventory is located. This information can be sorted by box number, box type, box size, location, customer name, driver last associated with moving the box, and other fields. The present invention contrasts with current inventory management practices through spreadsheets and data entry from route sheets. Further, the waste management system can eliminate the need for a clerk to track box locations and track rented boxes as a separate effort.

There are many expansion possibilities for a tool such as the waste management system. It is to be understood that the above aspects are only exemplary. Other embodiments are contemplated. For example, other embodiments can include multi-lingual units, electronic manifests, container inventory management into and out of the storage yards, and immediate invoices that can be handed to a customer by a driver.

Having described the general system and method of the present invention, reference is now drawn to the flow charts for a more detailed explanation of the system and method.

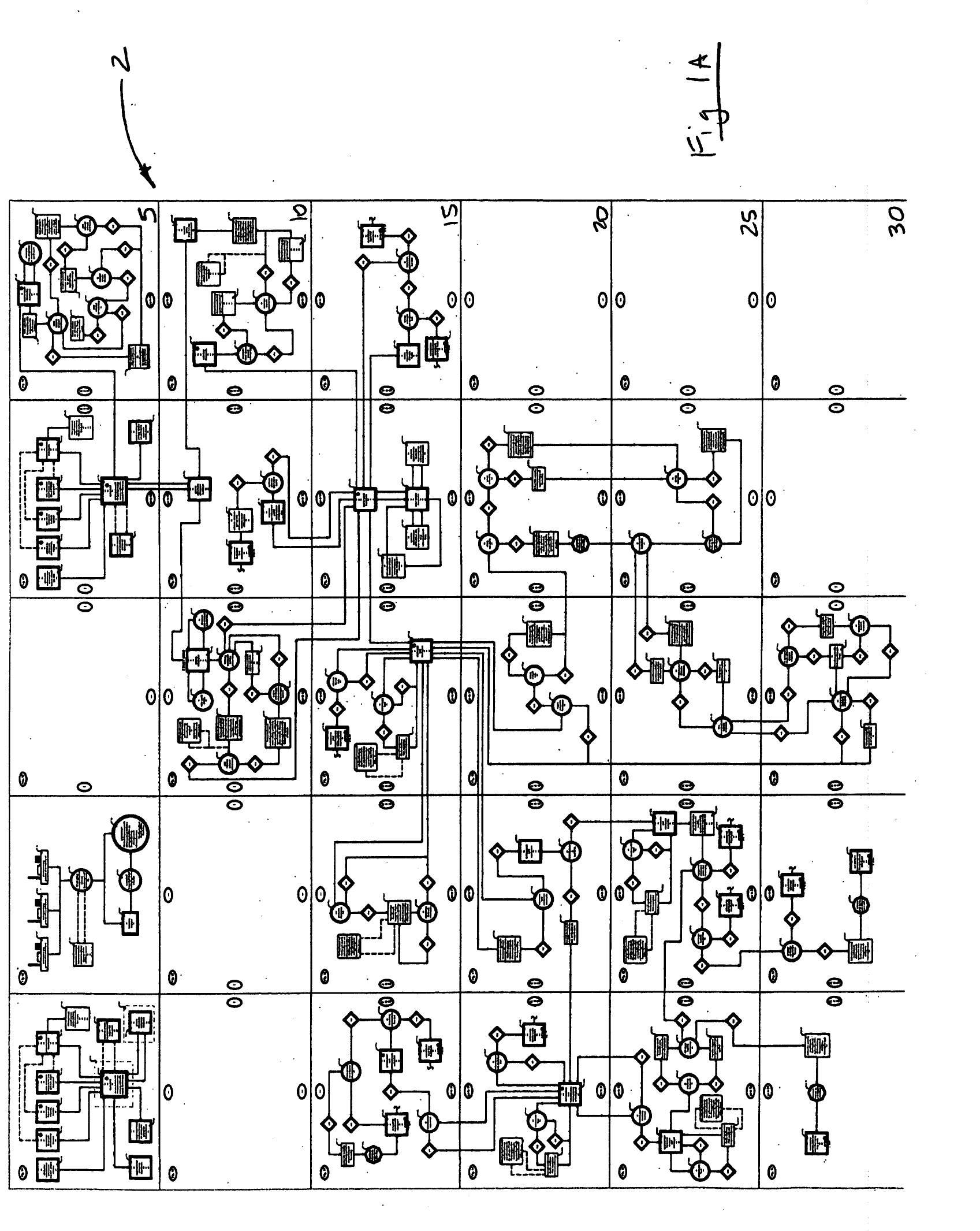

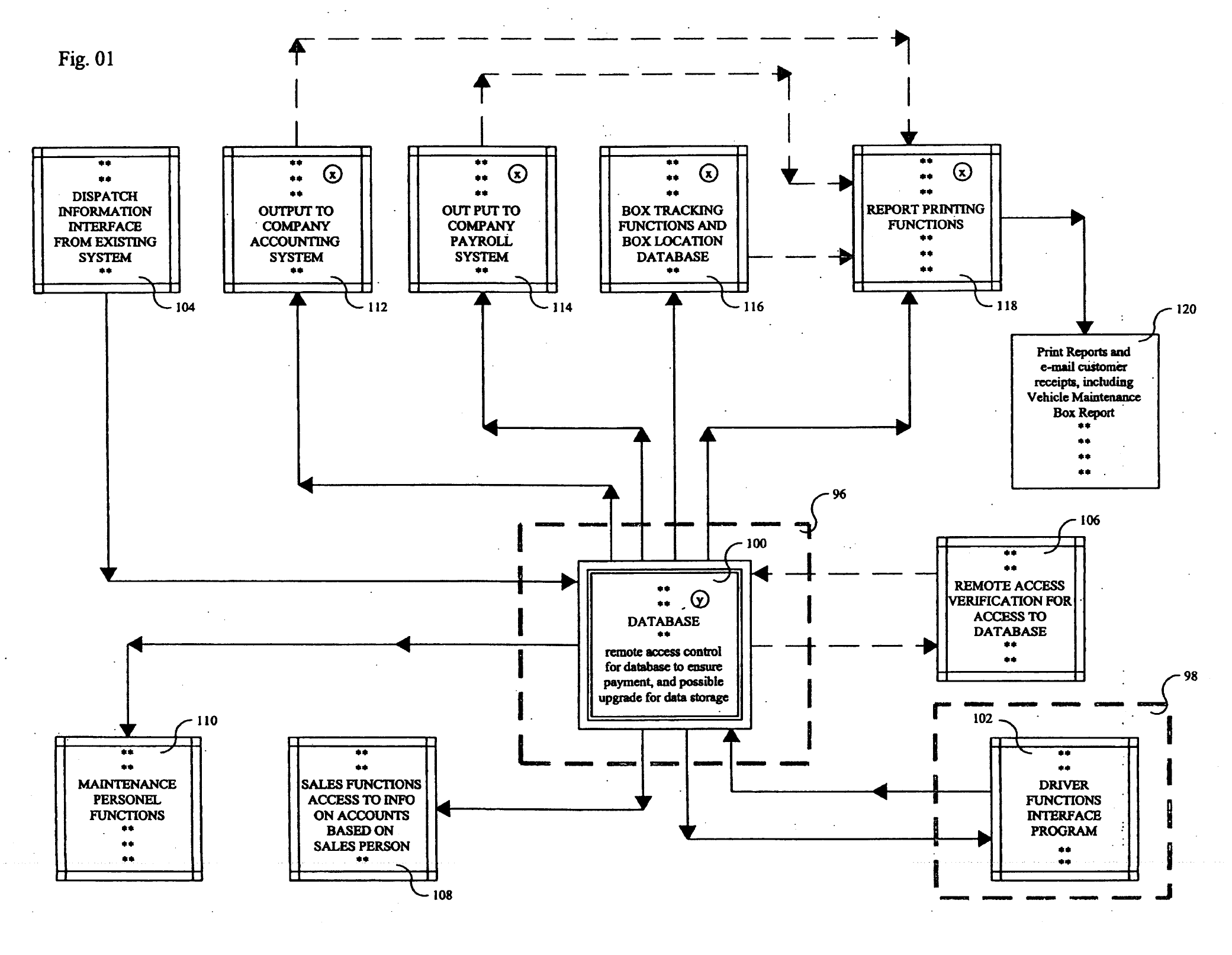

FIG. 1A is an overall schematic diagram of one embodiment of the present invention and serves as an index for the remaining figures. The index is useful in explaining the larger schematic and establishes each of the remaining figures in a grid pattern so that the relationship between the individual figures can be seen thereby. While the individual figures will be described in detail, it is to be understood that the individual figures relate to the overall schematic established in FIG. 1A. Further, it is to be understood that the schematics described herein represent only one embodiment of the waste management system 2, shown in FIG. 1A, as the invention may admit to other equally effective embodiments and are limited only by the claims herein.

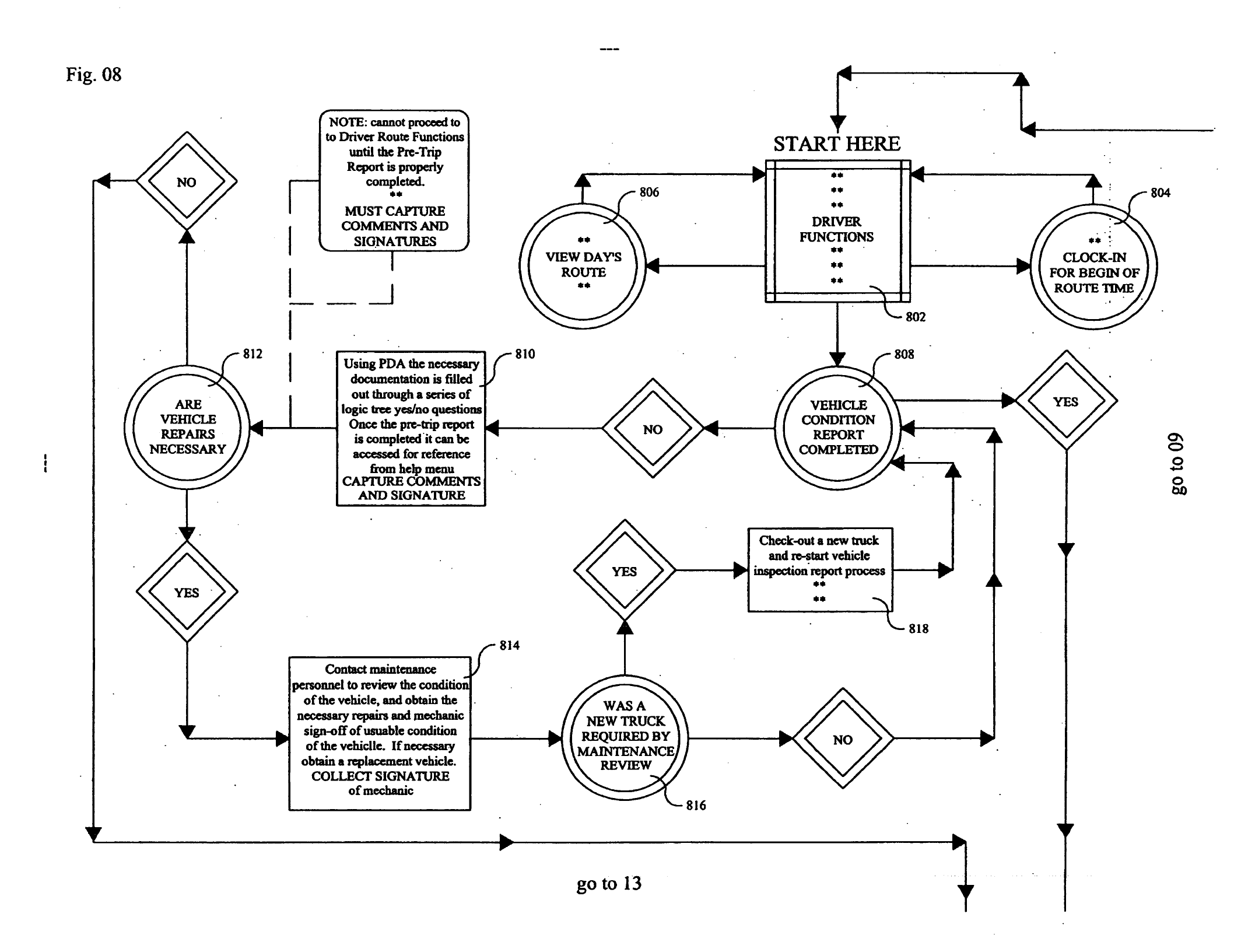

FIGS. 1, 2, 4, 5, 8-19, 21-24, and 26-28 are exemplary schematic diagrams corresponding to the index grid pattern established on FIG. 1A. The first row includes portions of the overall flow chart in spaces 1, 2, 4, 5 corresponding to FIGS. 1, 2, 4, 5. The second row includes flow chart portions in spaces 8-10 corresponding to FIGS. 8-10. FIGS. 3, 6, 7, 20, and 25 are not present to allow the figure numbers to correspond to the numbering established in the index grid of FIG. 1A.

FIG. 1 an overall schematic diagram of one embodiment of the waste management system illustrating the reporting, tracking, and output functions, database and base unit, and a portable unit with associated programs. One goal of the present invention is to include information obtained remotely by drivers into central database 100. For the present description, the terms “driver” and “operator” are used interchangeably. However, it is to be understood that the term “driver” is used broadly herein, and thus may include other functions besides simply driving a vehicle, as would be known to those with ordinary skill in the art. The database 100 generally receives input from the driver functions interface program 102. The database can be a centralized database or a plurality of databases that can communicate to one or more processors for integration therewith. The database 100 and driver functions interface program 102 communicate with each other and provide input and output between the program 102 and database 100, and related programs, to populate the database and provide information to the program 102. The term “program” is used broadly herein and includes, for example and without limitation, software, firmware and hardwired code, including routines, sub-routines, steps, lines, and commands. In general, the program(s) of the present invention can reside in a base unit, a portable unit, modems, printers, websites, or other electronic devices to compute, relate, interact, received input, generate output, and perform the other functions described herein.

In at least one embodiment, the database and associated programs can be reside in a base unit 96 and the driver interface functions can be housed in a portable unit 98. The base unit can be any computational electronic processor suitable for performing all or part of the duties described herein, including without limitation computers including desktops, laptops, notebooks, minicomputers, mainframes, super computers, and other electronic units. The portable unit can also be any computational electronic processor suitable for performing all of part of the duties described herein with the additional feature that it is portable with the operator, or with the operator's vehicle, during the route and can include without limitation laptops, notebooks, personal assistance devices, and other portable electronic units.

Another source of input is a dispatch information interface 104 from an existing system. An existing system is typically present in a waste hauling company or sometimes even from the customer. Thus, some input may be advantageous to help populate or update the database. The present invention can advantageously use an existing system to supply data and otherwise interface with the waste management system herein. Another source of input not shown is the general input provided by programmers and other data entry personnel that could input generally more static information, such as information that could be entered at a base location.

Advantageously, the database can provide remote access 106 to the database 100. In general, the access availability is determined after verification to control the access, viewing and retrieval of any information. The database 100 can provide output in a variety of ways. For example, the database 100 can provide output to enhance sales functions 108. The sales functions generally can allow access to the information based on accounts by sales persons, customers, size, quantity of waste holes, disposal sites, and any other sorting of data, as can be available from the database 100. Further, the database 100 can be used to assist maintenance personnel functions 110 through various portions of a program. The maintenance personnel functions 110 can be useful for tracking the maintenance on the vehicles, alerting to any anomalies or tendencies of premature failures, scheduling of routine maintenance, and other maintenance functions.

Further, the database can provide data for output to an accounting system 112, a payroll system 114, and box tracking functions and box location database 116. Each of the various systems and databases 112, 114, 116, and others can be directed to at least one type of output, such as the report printing functions 1118, another portion of the waste management system 2, shown in FIG. 1A. The report printing functions 118 can produce reports, customer receipts, maintenance reports, invoices, and other features normally associated with the waste management system, in hard copy or electronic formats and communications.

In general, the present invention bridges the gap that heretofore has been unanswered. The management system can be managed virtually seamlessly through the driver functions interface and an electronic portable unit that accompanies the operator during the waste removal. The data gained from the operator during the route while performing the waste removal activities can be uploaded into the database with other related programs. From the database 100, the various functions throughout the waste management system including the sales functions, maintenance functions, dispatch information, output to accounting and payroll, and even tracking of boxes or other waste storage units, can be performed. From the various outputs and information available, sales, personnel, managers, and even customers with authority to access specific portions of the waste management system 2, can receive information, such as invoices and other reports.

This integration contrasts starkly with waste management systems prior to the present invention that rely upon a significant amount of copies of receipts, misdirected signatures, lost documents, and input from a variety of sources that were manually entered into database 100. Thus, the present invention automates the data input and retrieval through the interface with the driver functions interface program 102, described below. While there has been a long felt need for such interface and automation, the waste management industry simply has not had the capability for such interface prior to the present invention. The present invention solves the long felt need as described herein.

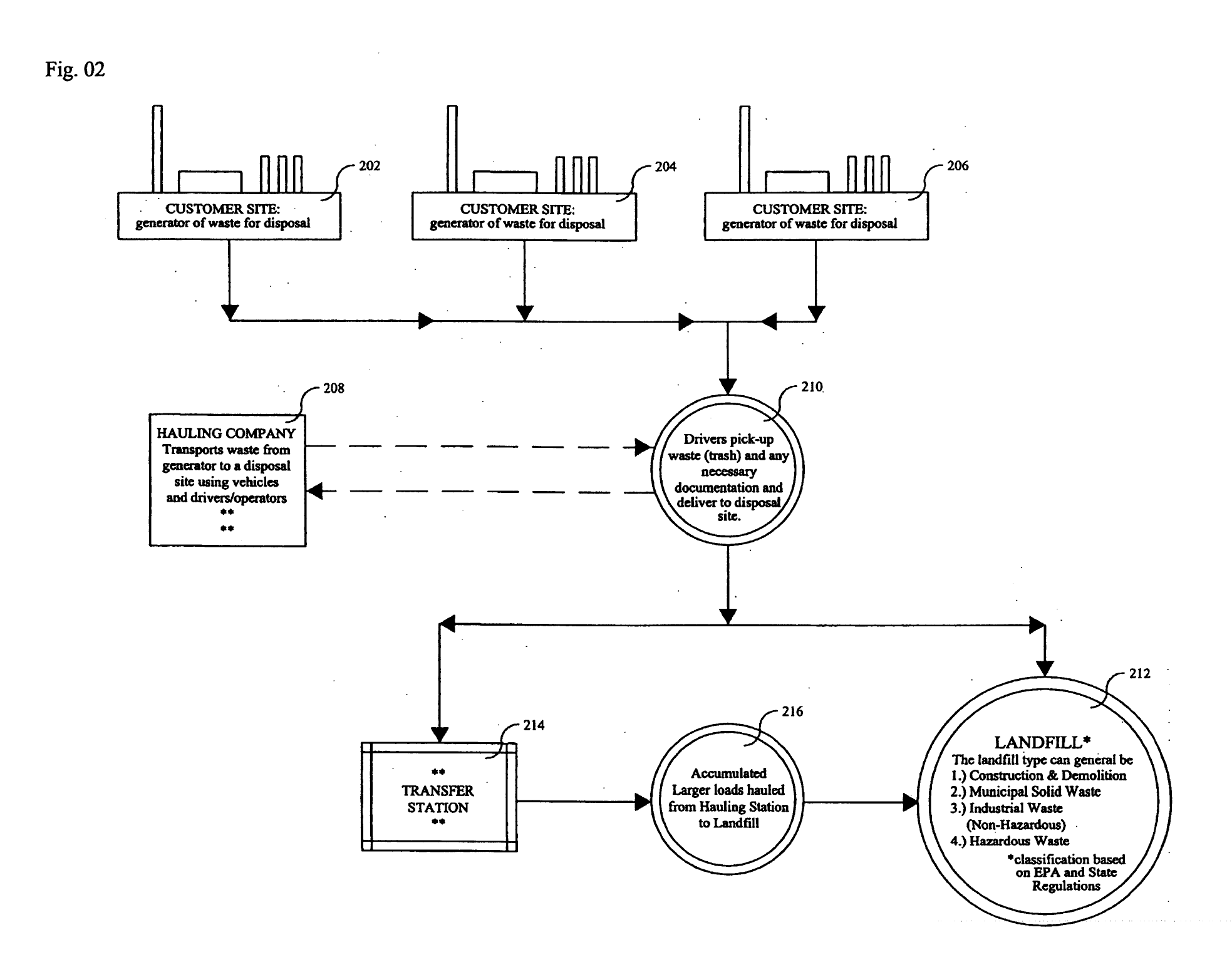

FIG. 2 is an overall schematic diagram of an interrelationship between customers' facilities, a hauling company, operators, and disposal locations. To better understand the overall waste management system, it may be helpful to briefly describe the flow of wastes from the customer facility to the disposal site. In general, one or more customer facilities 202, 204, 206 generate wastes for disposal. The customer facilities can be small shopping center drive-ins to very large industrial complexes, and others.

Typically, industrial waste requires environmental manifests to accompany the waste from a generator to handling to ultimate disposal with signatures at various steps of the process. The manifest is then submitted to environmental agencies, such as the federal EPA or an associated state-level agency. Obtaining correct signatures is very important to fulfilling the obligations required by the manifest. Other types of documents, signatures, and other input can also be required along the path from the generator of the waste to the ultimate disposal site. Often documentation, whether electronic or paper, is necessary for proper invoicing and payroll. Thus, the hauling company, customers, drivers, and operators of disposal sites are all interested in obtaining various portions of the information.

To remove the waste, a hauling company 208 transports the waste from the generator to the disposal site using vehicles and drivers/operators. The operators 210 pick up the waste from the customer sites, attempt to obtain necessary documentation, and deliver the waste to a disposal site. In some cases, the disposal route is direct to the disposal site 212.

Depending on the particular waste, different disposal sites are needed. The disposal site in general is a landfill and can be a single or multi-function disposal site. For example, some disposal sites can accept construction and demolition waste, whereas other disposal sites can treat municipal waste. Still other disposal sites can treat industrial wastes that is nonhazardous, and there are sites for hazardous waste. In some cases, the same disposal sites can treat multiple types of waste.

Depending on the waste type and quantity, sometimes the operators 210 may deliver the waste to a transfer station 214. The transfer station 214 allows an accumulation 216 of the waste so that a larger and more economically efficient haul can be made to the disposal site 212.

Having described various generalities of the present invention shown in FIGS. 1-2, attention is now directed to details of the system and particularly the driver functions interface program 102 described in FIG. 1.

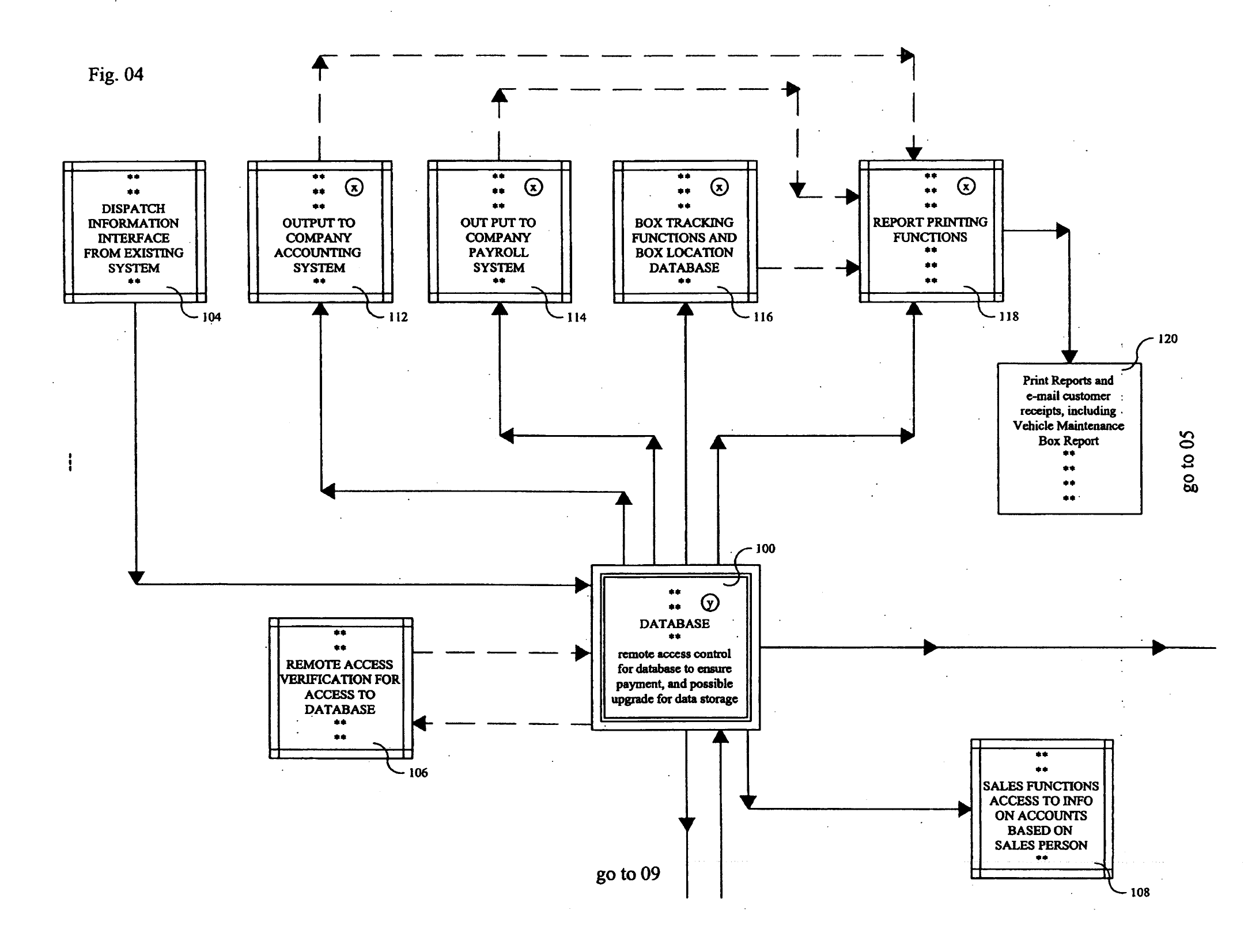

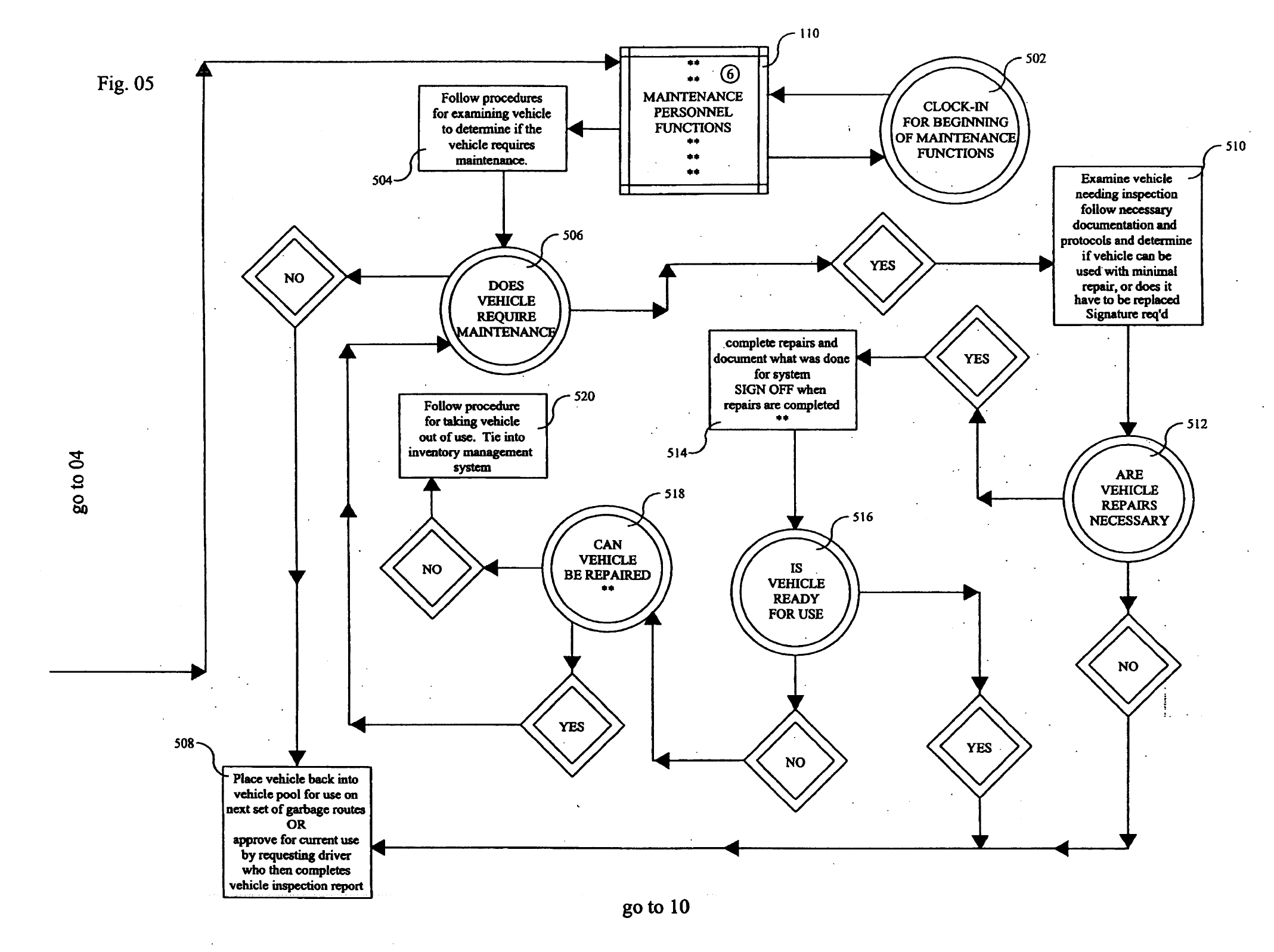

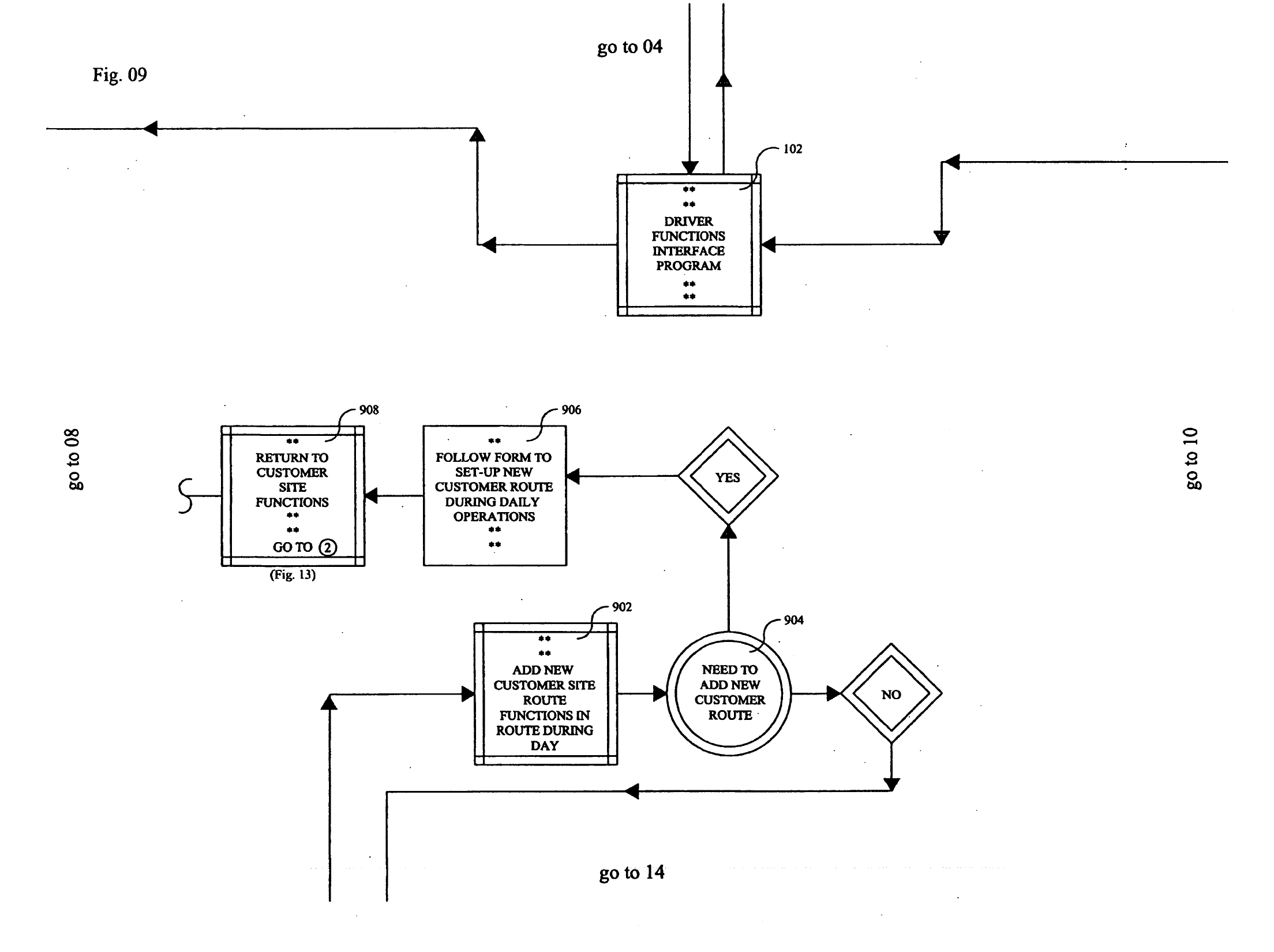

FIG. 4 is an overall schematic diagram of one embodiment of the present invention regarding possible functions with a database at an office or other location. For context, FIG. 4 shows various aspects of the input to and output from the database 100 in FIG. 1, but without either the maintenance personnel functions 110 or the driver functions interface program 102, where the maintenance personnel functions 110 and the interface program 102 is described in reference to the other figures. Similar elements are similarly numbered. Where logic flow lines exit or enter from the edges of the figures, the flow line can be seen on adjacent figures. The figure numbers are referenced to the index grid, shown on FIG. 1A. For example, the database 100 interfaces with the maintenance personnel functions 110 through the flow line that extends to the right of the page into FIG. 5, described below. Also, the database 100 interfaces with the driver functions interface program 102 through the flow line that exits the bottom of the page of FIG. 4 and enters on FIG. 9, as shown on the indexed layout in FIG. 1A. Returning to FIG. 4, the various inputs and outputs have been previously described in reference FIG. 1. The database is populated and provides information for a variety of functions in the waste management system where the information primarily derives from the portable unit that is used by the operator while performing waste removals.

FIG. 5 is a schematic diagram of maintenance personnel functions, described briefly in FIG. 1. In general, the maintenance personnel functions 110 allow for input regarding vehicle examination, maintenance, repair, and associated functions such as timekeeping. For example, maintenance personnel can use the clock in functions 502 when beginning maintenance functions. The time for clock in (and later clock out) is inputted into the maintenance personnel functions 110.

An examination 504 occurs on the vehicle by either the operator of the vehicle of the waste removal or by another person, such as maintenance personnel. The examination can proceed at any level, including a light visual inspection, a complete bumper to bumper inspection, or intermediate level inspections. In general, it is envisioned that the examination will proceed with a pre-established checklist. The checklist can appear on the portable unit 98, shown in FIG. 1, that accompanies either the operator or the maintenance personnel. Thus, the portable unit could include preprogrammed queries that require operator or maintenance personnel input as to the particular condition. This input can be uploaded at some point into the maintenance personnel functions 110 and thence to the database 100 described in FIG. 1 for tracking on a per equipment basis or other indicia.

If the vehicle does not need maintenance, then it is placed in the vehicle pool for use for waste removal or approved for current use by the requesting operator in block 508. The operator should complete a vehicle inspection report. If the vehicle does require maintenance, then a further examination and determination 510 is made if the vehicle can be used with minimal repair or if it has to be replaced for the particular route for which it was intended.

Part of the decision process is a further determination 512 of whether the vehicle repairs are necessary at that time or can be delayed. If they can be delayed, then the vehicle is placed in the vehicle pool 508. If they are presently necessary, then the repairs 514 are done. In some embodiments, it is required that the repairs be signed off when completed. Again, this information can provide traceability for the personnel, the hauling company, and other record keeping. When used with the portable unit 98, the information can be easily input into the database 100 described in FIG. 1 contemporaneously or at later uploads.

After the repairs, a further determination 516 is made as to whether the vehicle is ready for use. At that point, if it is ready for use, it is placed back in the vehicle pool 508. If it is not ready for use, then a further determination 518 is made as to whether or not it can be further repaired to correct the remaining problems. If it can be repaired, it is placed into the examination and maintenance loop described above. If it cannot be repaired, then a procedure 520 is followed for taking the vehicle out of use. The information can be linked with the inventory management system for scheduling purposes.

FIG. 8 is a schematic diagram of some exemplary features of the driver functions. (FIGS. 5-7 are not present or numbered since no portion of the system flowchart appears in the corresponding spaces of the index grid of FIG. 1A.) The driver functions 802 is linked to the driver functions interface program 102 described in reference to FIG. 1 and FIG. 9. The driver functions interface program 102 is linked to the driver functions 802 through the flow line entering FIG. 8 from the right. The driver functions can generally begin with an operator clocking in for beginning the route time in block 804. Similarly, the driver can also view the day's route in block 806.

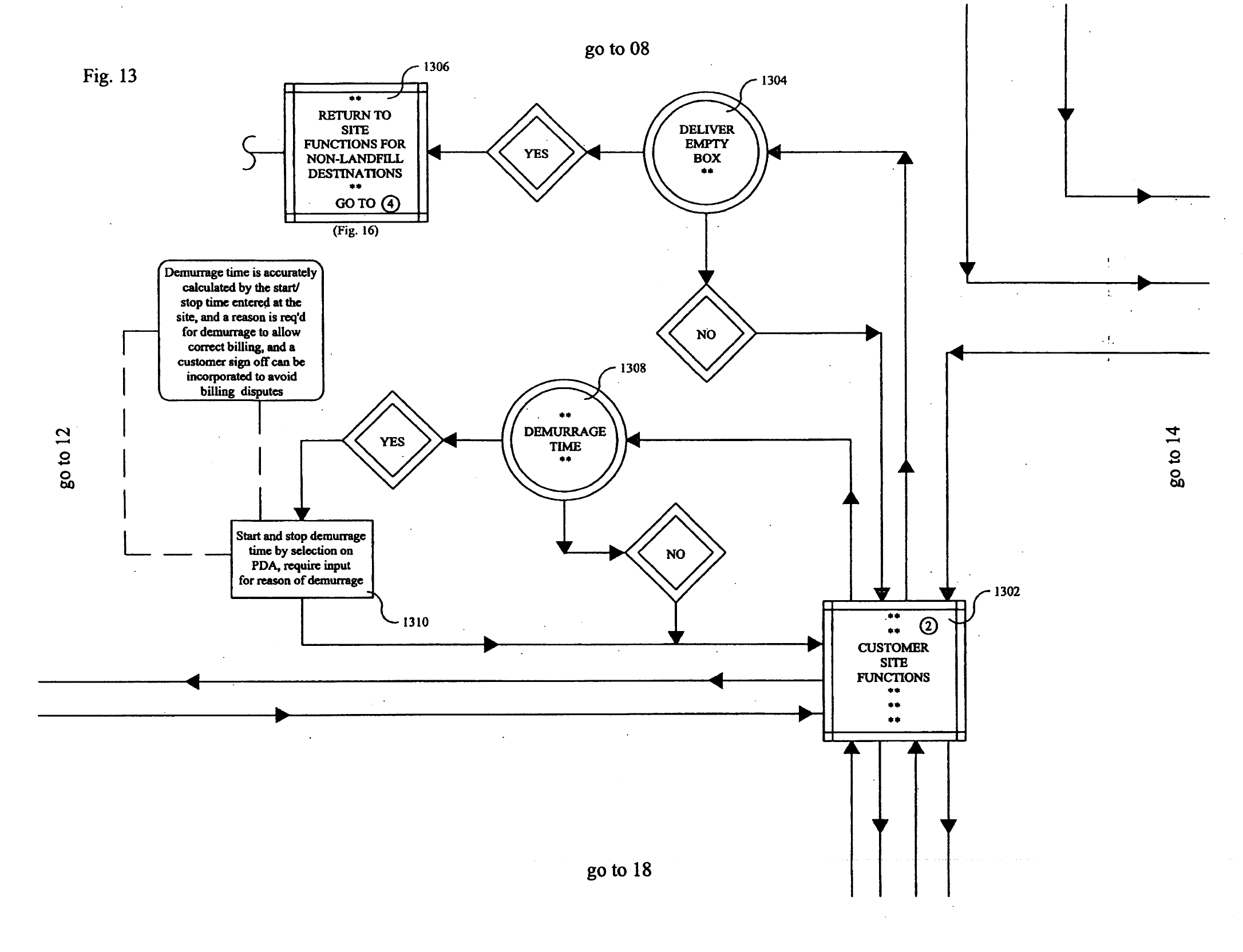

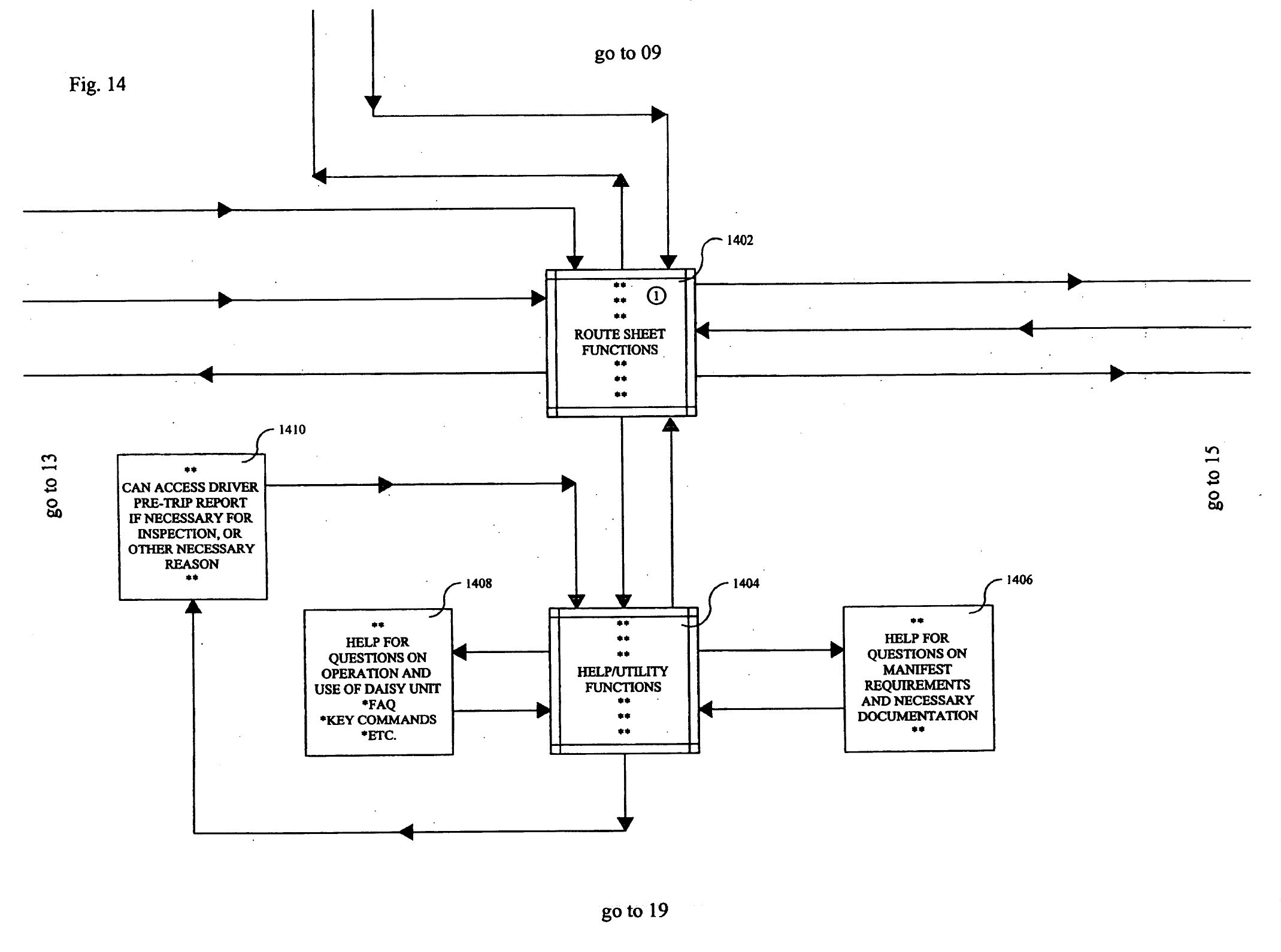

The operator can also make a determination 808 as to whether a vehicle condition report has been completed. If the vehicle condition report has been completed, then the program is directed to the route sheet functions 1402, shown in FIG. 14 and connected to FIG. 8 through the flow line exiting the bottom right of FIG. 8 and passing through FIG. 13 to FIG. 14. If the vehicle condition report has not been completed, then the vehicle report is completed in block 810. In at least one embodiment, a portable unit contains preprogrammed queries that the operator can answer. For example, a logic tree of “yes” and “no” questions can be asked. Once a pretrip report is completed, the report can be accessed for reference from a help menu, forwarded to populate the database 100 described in reference to FIG. 1, or other functions for reporting requirements. Further, the pretrip inspection report can be used to capture comments and signatures for traceability. In at least one embodiment, the driver route functions cannot be accessed by the operator until the pretrip report is properly completed.

As part of the pretrip report, it may become apparent that the vehicle needs further assistance. Thus, a determination 812 is made as to whether any vehicle repairs are necessary. If no vehicle repairs are necessary, then the program can be directed to the route sheet functions 1402, shown in FIG. 14. The link from FIG. 8 to FIG. 14 is shown by the flow line exiting the center bottom of FIG. 8, passing through FIG. 13, and entering from the right on FIG. 14 into the side of block 1402.

If the determination 812 indicates that vehicle repairs are necessary, then the operator can contact maintenance personnel and have the necessary repairs completed in block 814. Generally, the operator will obtain the signature on the portable unit of the mechanic performing the repairs. A further determination 816 may be necessary as to whether a new truck is required when the repairs are substantial or when the previously completed repairs did not fix the problem. If a new truck is not required, the program returns to the determination 808 as to whether the vehicle condition report is then completed and subsequent processes as described above after determination 808. If a new truck is required, then the operator checks out a new truck and re-starts the vehicle inspection report process in block 818.

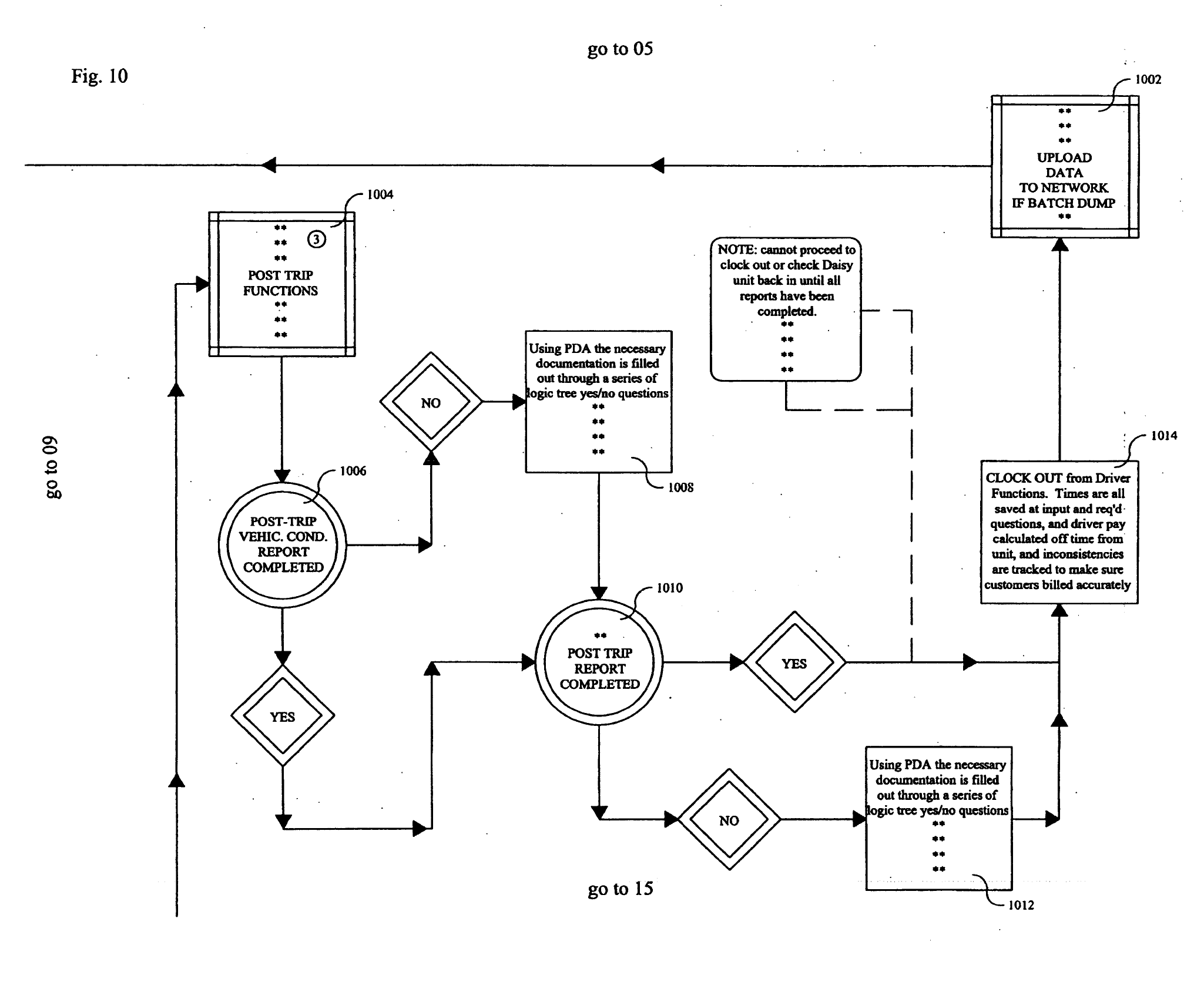

FIG. 9 is a schematic diagram of the driver functions interface program and various aspects of adding a new customer site. The driver functions interface program 102 has been described in reference to FIG. 1. The driver functions interface program provides a link from the database 100, referenced in FIG. 1, through the flow line entering the top of FIG. 9. The driver functions interface program 102 also is linked to an upload data process 1002, referenced in FIG. 10, through the flow line entering the right side of FIG. 9. The driver functions interface program 102 further links to the start of the driver functions 802, referenced in FIG. 8, through the flow line exiting the left side of FIG. 9.

Further, FIG. 9 illustrates a portion of a schematic when a new customer site is added, as a portion of the route sheet functions 1402, shown in FIG. 14. In general, at various times through the process, the operator can be directed to retrieve or haul waste from a new customer site, while the operator is performing route duties. The portable unit can allow such information to be input by the operator or through an electronic transmission to or from the portable unit, so that associated data can be collected for a new customer route and then uploaded immediately or later to the database 100, shown in FIG. 1. For example, the operator could be directed to add a new customer site route. To add such a route, the operator can access the customer site route functions 902 of the programming. The customer site route functions 902 in FIG. 9 is linked to FIG. 14 by the flow line from the route sheet functions 1402, referenced in FIG. 14, entering the bottom of FIG. 9.

A determination 904 is made as to whether a new customer route 904 is necessary. If one is not needed, then the program can link back to the route sheet functions 1402, shown in FIG. 14. If a new customer route is needed, then the operator can follow a preprogrammed form in block 906 to set up the new customer route, while the operator is in the field performing daily operations. After entering the new customer route, the program can return in block 908 to customer site functions 1302, referenced in FIG. 13.

FIG. 10 is a schematic diagram that generally relates to reporting functions that are uploaded to the database 100, shown in FIG. 1. In general, the present invention provides for uploading data to the database at the end of the route when the operator returns to base, such as the hauling company, or periodically during the route, for example, through wireless transmissions. The following description generally uses the term “post trip,” but it is to be understood that similar functions would be required for periodic reporting during the route, and thus the steps and functions described apply to such periodic reporting herein.

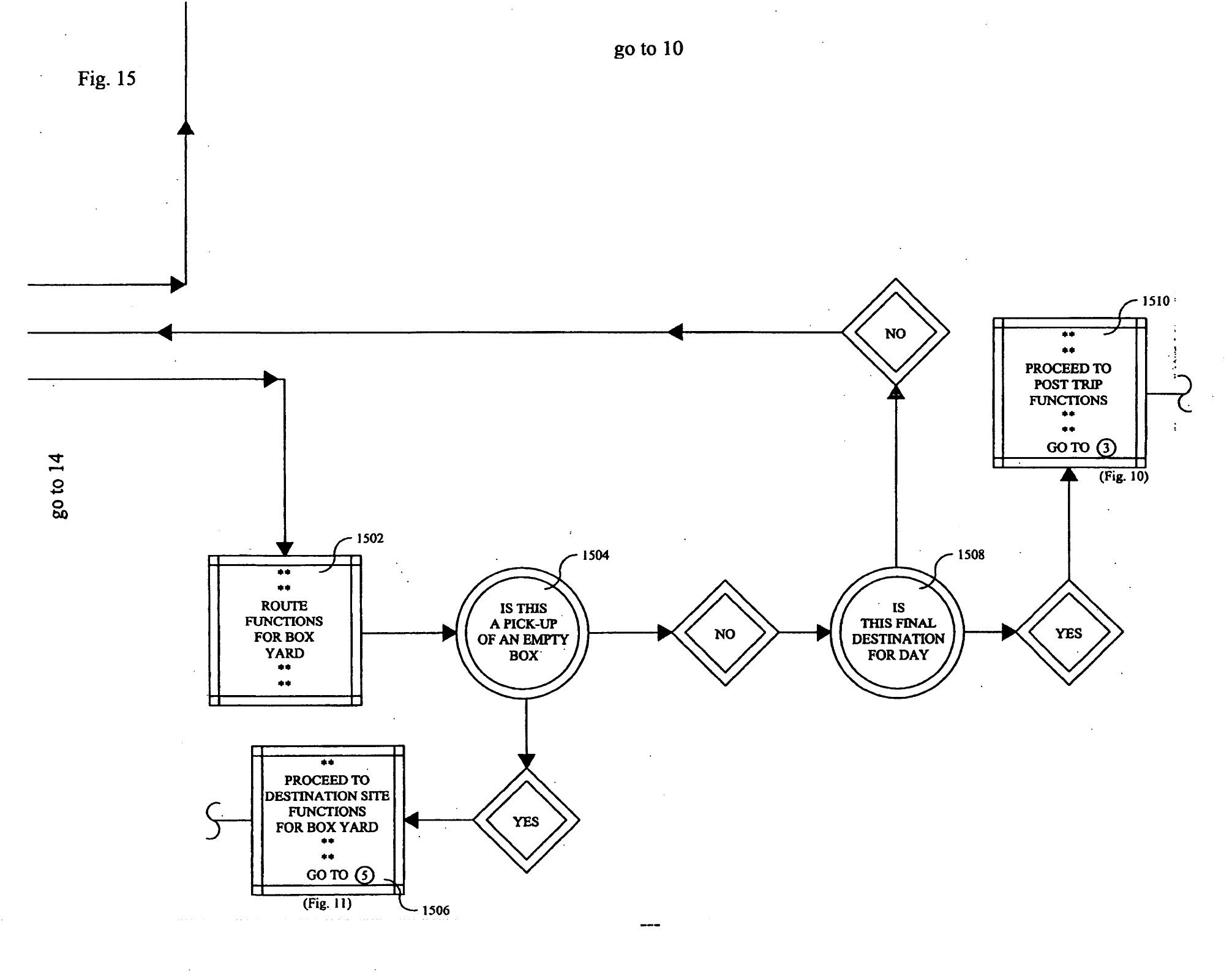

A portion in the program known as the post trip functions 1004 can be linked to the route sheet functions 1402, shown in FIG. 14. The flow line from the route sheet functions 1402 passes through FIG. 15 and into the post trip functions 1004 through the flow line entering the bottom left of FIG. 10. The post trip functions 1004 in at least one embodiment inquires whether a post trip vehicle condition report has been completed in block 1006. If the post trip vehicle condition report is not completed, then the portable unit can provide a logic tree sequence of preprogrammed questions that the operator can answer and provide input in block 1008. Once the post trip vehicle condition report is completed, then a determination 1010 can be made as to whether a post trip report has been completed. Generally, the post trip report would include various aspects of the route, the operator, the waste removal, and other information of the waste management system. If the post trip report is not completed, then the portable unit can provide various preprogrammed queries for the operator to provide input in block 1002. Once the post trip report is completed, the operator can clock out of the program in step 1014.

Various event times and responses to any queries are saved at the different input points along the route. In at least one embodiment, the operator's compensation, customer invoice amounts, and other information can be calculated from the entries in the portable unit and any inconsistencies tracked. The data can be uploaded to the base unit 96, shown in FIG. 1, either in a batch format or in periodic packets of data, as shown in block 1002. The upload in block 1002 can interface with the driver functions interface program 102, shown in FIG. 9. The driver functions interface program 102 can further provide the information to the database 100, shown in FIGS. 1 and 4.

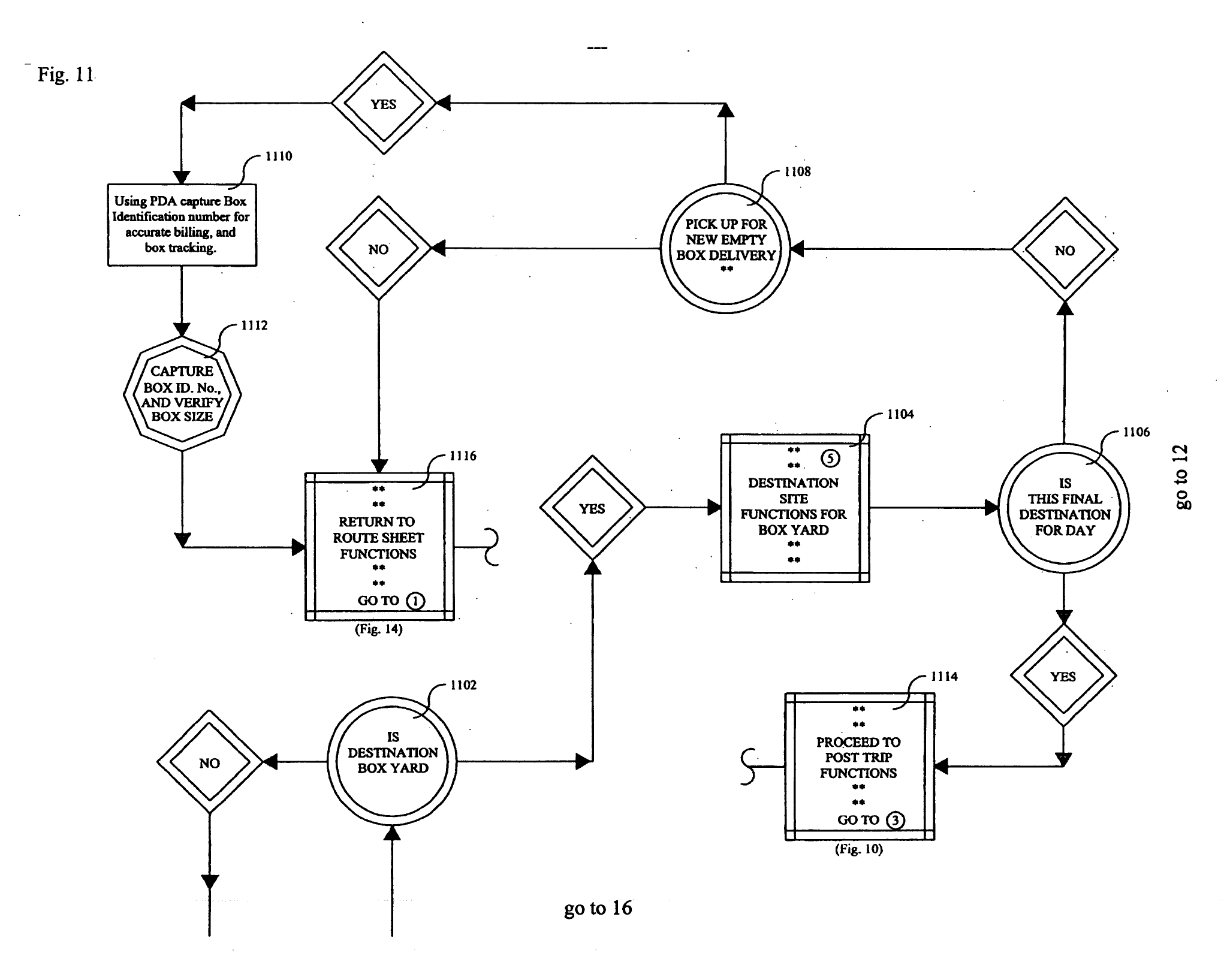

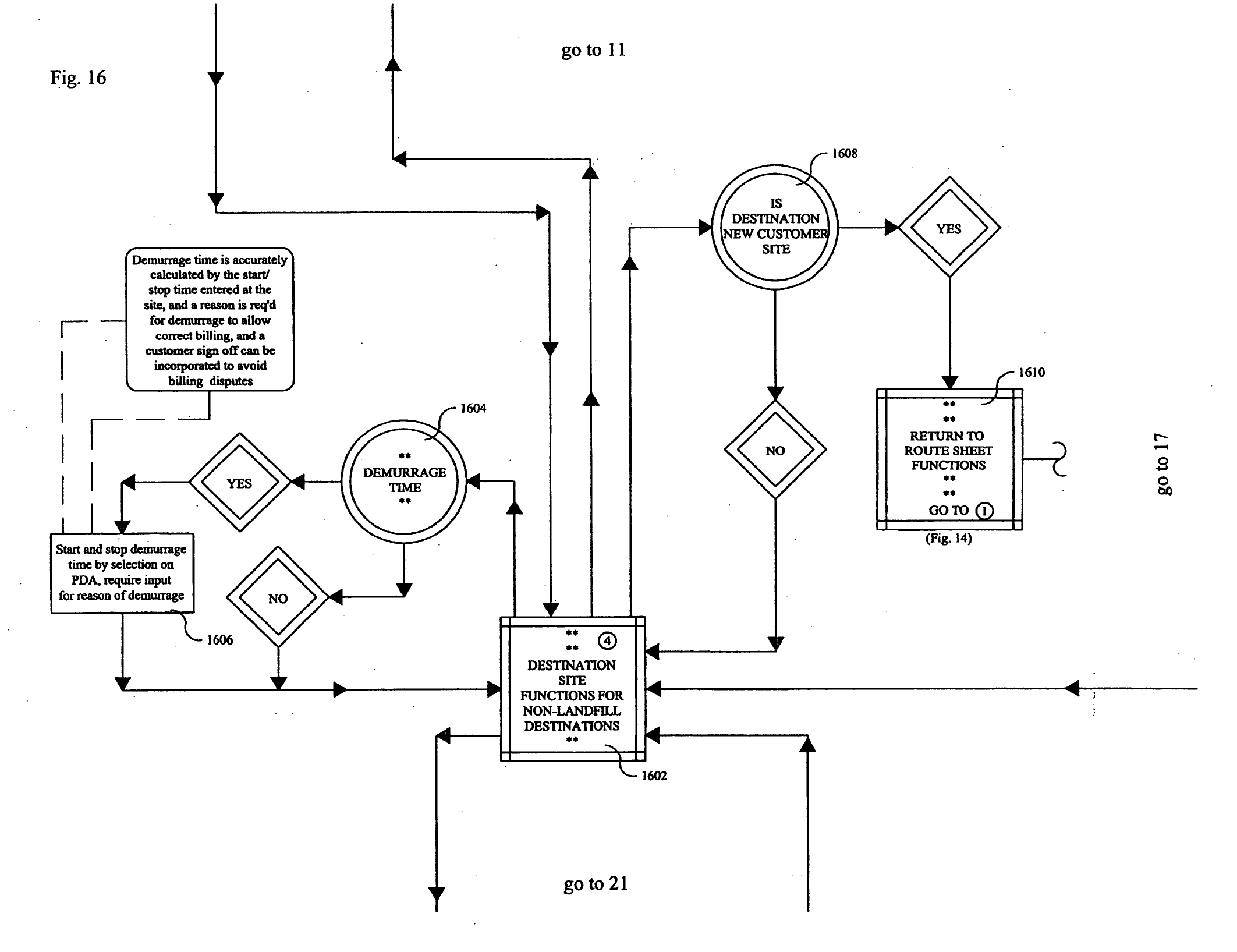

FIG. 11 is schematic diagram of a portion of the flowchart relating to destinations and tracking of a waste storage unit. The flow line entering FIG. 11 from the bottom center is connected in the flowchart to a destination site function for non-landfill destinations 1602, referenced in FIG. 16. A determination 1102 is made as to whether the destination is a box yard in block 1102. The box yard is typically where the waste storage unit, generally denoted as a “box” herein (without limitation to the size, shape, or characteristics of the box), is stored for later retrieval and use at various customer facilities. If the destination is the box yard, the program is directed to the destination site functions for the box yard 1104. A determination 1106 is made as to whether the destination in the box is the final destination for the day. If so, then the box can be delivered to the box yard, or left in the box yard if already present, and the program initiates a return in block 1114 to post trip functions 1004, shown in FIG. 10. If the destination of the box in the box yard is not the final destination for the day, a determination 1108 can be made as to whether an operator should pick up a new empty box and deliver it to a customer facility. If the answer is yes, the portable unit can be used to capture, in block 1110, a box identifier, such as identification number, for accurate billing and box tracking. In some embodiments, a bar code can be used and scanned into the portable unit. In other instances, other identification notice can be manually or automatically input, including keyboarding the information, using a touch screen, a wireless interface, such as an infra-red or electromagnetic transducer, a voice recognition interpreter so the operator can dictate the box tracking number, preprogrammed cards that can be for example swiped through a card reader, combinations thereof, and other input formats as may be useful to the present invention. The block 1112 represents the input of such information as box identifiers, automatically or through operator input. The program can then initiate a return 1116 to the route sheet functions 1402, shown in FIG. 14.

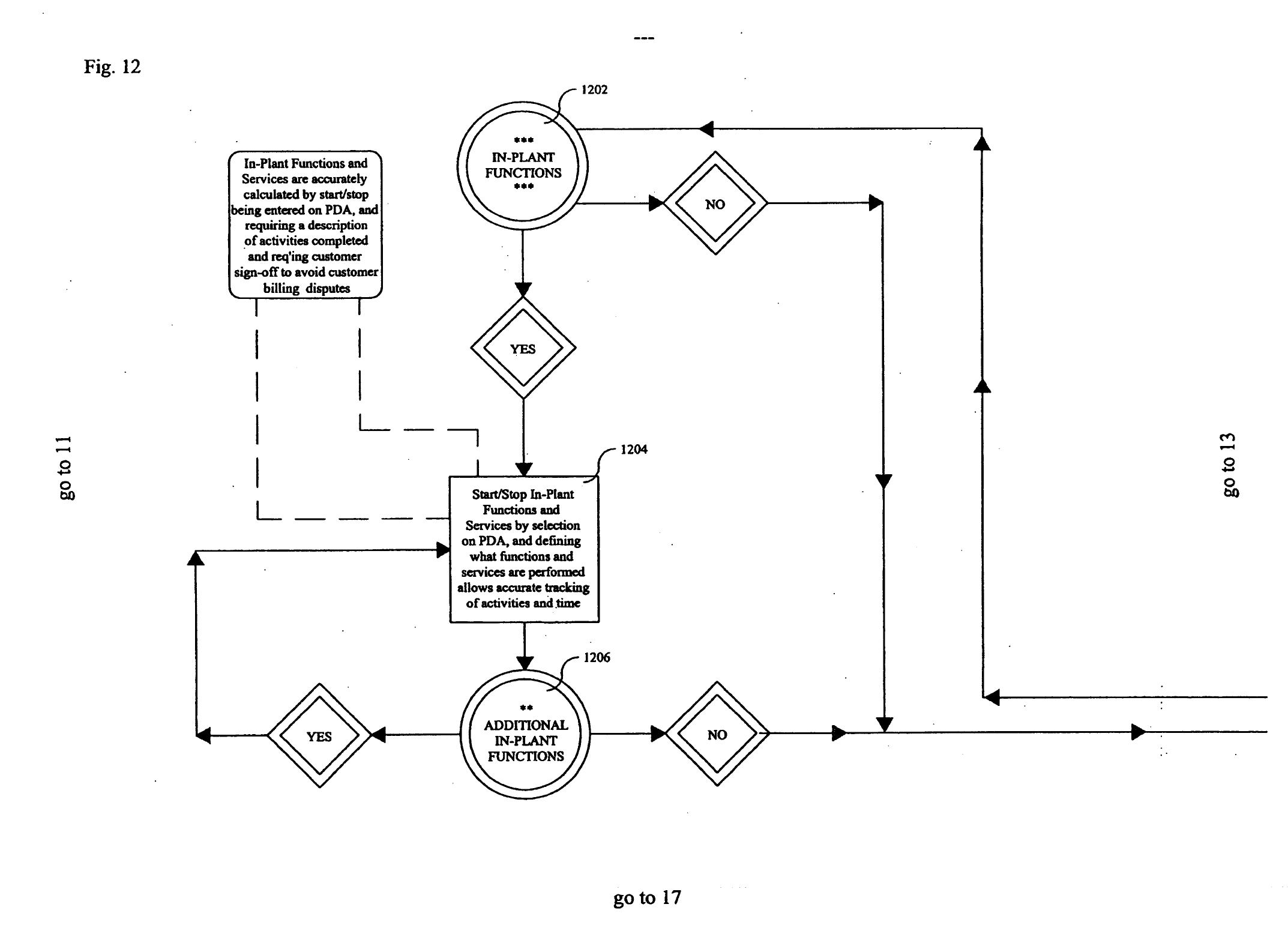

FIG. 12 is a schematic diagram of the portion of the in-plant functions performed by the operator. The functions illustrated in FIG. 12 relate to a portion of the program described as the “customer site functions” 1302, shown in FIG. 13. Through the customer site functions 1302 in FIG. 13, a determination 1202 in FIG. 12 can be made as to whether in-plant functions are needed. The term “plant” is used broadly and includes a variety of facilities, whether an industrial facility, packing facility, shipping facility, or other generators of waste, and thus, the term “facility” is used in the claims. In FIG. 12, if there are no in-plant functions to perform, the program can return to the customer site functions 1302, shown in FIG. 13. If there are in-plant functions, the operator can stop and start the in-plant functions routines in block 1204 by various selections on the portable unit. Generally, the functions and services will be preprogrammed in the form of queries to which the operator can respond. In other instances, the operator may need to add comments or other information that may not necessarily be predetermined, depending on the circumstances. The portable unit can provide for both types of input.

Once the operator or other personnel respond to the various input requests of the portable unit, the program can make a determination 1206 as to whether there are any additional in-plant functions. If there are none, the program is returned to the customer site functions 1302, shown in FIG. 13. If there are, the system returns to the block 1204 for additional input. It is to be noted that the portable unit can also be used to calculate start/stop times through a clock interface, a description of activities, and a requirement for a customer signature, which may alleviate future customer billing disputes.

FIG. 13 is a schematic diagram of additional features of the customer site functions portion of the program. The customer site functions 1302, described above in reference to the determination 1202 shown in FIG. 12, form a portion of the program that in general relates to the customer site operations, including for example, in-plant functions while the operator is present, calculation of demurrage time which may occur from delays, customer instructions, destination sites, plant hauling functions, and other aspects of the present invention. Further, the customer site functions 1302 can be linked to the route sheet functions 1402, referenced in FIG. 14.

In FIG. 13, a determination 1304 is made as to whether an empty box is to be delivered. If an empty box is not to be delivered, then the program returns to the customer site function 1302. If an empty box is to be delivered, the program returns in block 1306 to the site functions for non-landfill destinations 1602, referenced in FIG. 16 for further action. Such action can include, for example, the box can be returned to a box yard, described in reference to FIG. 11.

Further, the customer site functions 1302 can also be used to determine demurrage time 1308. If the demurrage time is applied, such as from a delay in being able to access or empty the box at the customer facility, then the demurrage time can be calculated using either operator input or an automatic clock function for the program. Further, the portable unit can require operator input as to the reason for the demurrage time to provide a contemporaneous recordation of input, in reference to block 1310. This input can advantageously allow for correct billing and can include a customer sign-off to be incorporated therein to avoid subsequent billing disputes.

FIG. 14 is a schematic diagram of a portion of the route sheet functions and help/forward utility functions. In general, the route sheet functions 1402, referenced above, provide a link to the customer site functions 1302, referenced in FIG. 13, to driver functions 802, referenced in FIG. 8, and to post trip function 1004, referenced in FIG. 10. Further, the route sheets function 1402 can provide help and utility functions 1404. For example and without limitation, the help and utility functions can include help for questions on manifest requirements and necessary documentation 1406. The help and utility functions 1404 can also include help in block 1408 for questions on the operation and use of the portable unit, including frequently asked questions, key commands, and so forth. Further, the help and utility functions 1404 can allow the operator to access the pretrip report for inspection and other reasons in block 1410. Other help utility functions can be appropriate for particular situations.

FIG. 15 is a schematic diagram of a portion of the program related to block functions in the box yard. A route functions for box yard 1502 portion of the program is related to the route sheet functions 1402, referenced in FIG. 14. In general, the route functions for box yard 1502 allows a determination 1504 of whether the pick up by the operator is an empty box. If the pick up is an empty box, the programming can direct the program in block 1506 to proceed to the destination site functions for box yard 1104, shown in FIG. 11. If the box yard as a destination is not for the pick up of an empty box, a determination 1508 is made as to whether the driver/operator is at the box yard for the final destination of the day. If not, program can proceed to the route sheet functions 1402 for further directions, shown in FIG. 14, this can result from dropping off an empty box before proceeding to the next item on the route sheet. If the destination of the box in the box yard is the final destination for the day, the program can return in block 1510 to the post trip functions 1004, shown in FIG. 10.

FIG. 16 is a schematic diagram of a portion of the program relating to destination site functions for non-landfill destinations. The destination site functions for non-landfill destinations 1602 is linked to the program in at least one embodiment by determining if the destination is a box yard, as is described above in reference to FIG. 11. The destination sites function can include a determination 1604 as to whether demurrage time is applicable at the destination site. If the demurrage time is inapplicable, the program returns to the destination site functions for non-landfill destinations 1602. If demurrage time is applicable, the operator can start and stop demurrage time, or the portable unit can be programmed to automatically start and stop demurrage time, as shown in block 1606. Further, the program can require input by the operator or other personnel as to the reason for the demurrage. In general, the demurrage time can be accurately calculated by using the start and stop time entered at the site. Further, a customer signature can be requested, which may alleviate future customer billing disputes.

The destination site functions for non-landfill destinations 1602 can also include a determination 1608 as to whether the destination is a new customer site. If the destination is not a new customer site, the program can return to the destination site functions for non-landfill destinations 1602. If it is, the program can return, in block 1610, to the route sheet functions 1402, shown in FIG. 14.

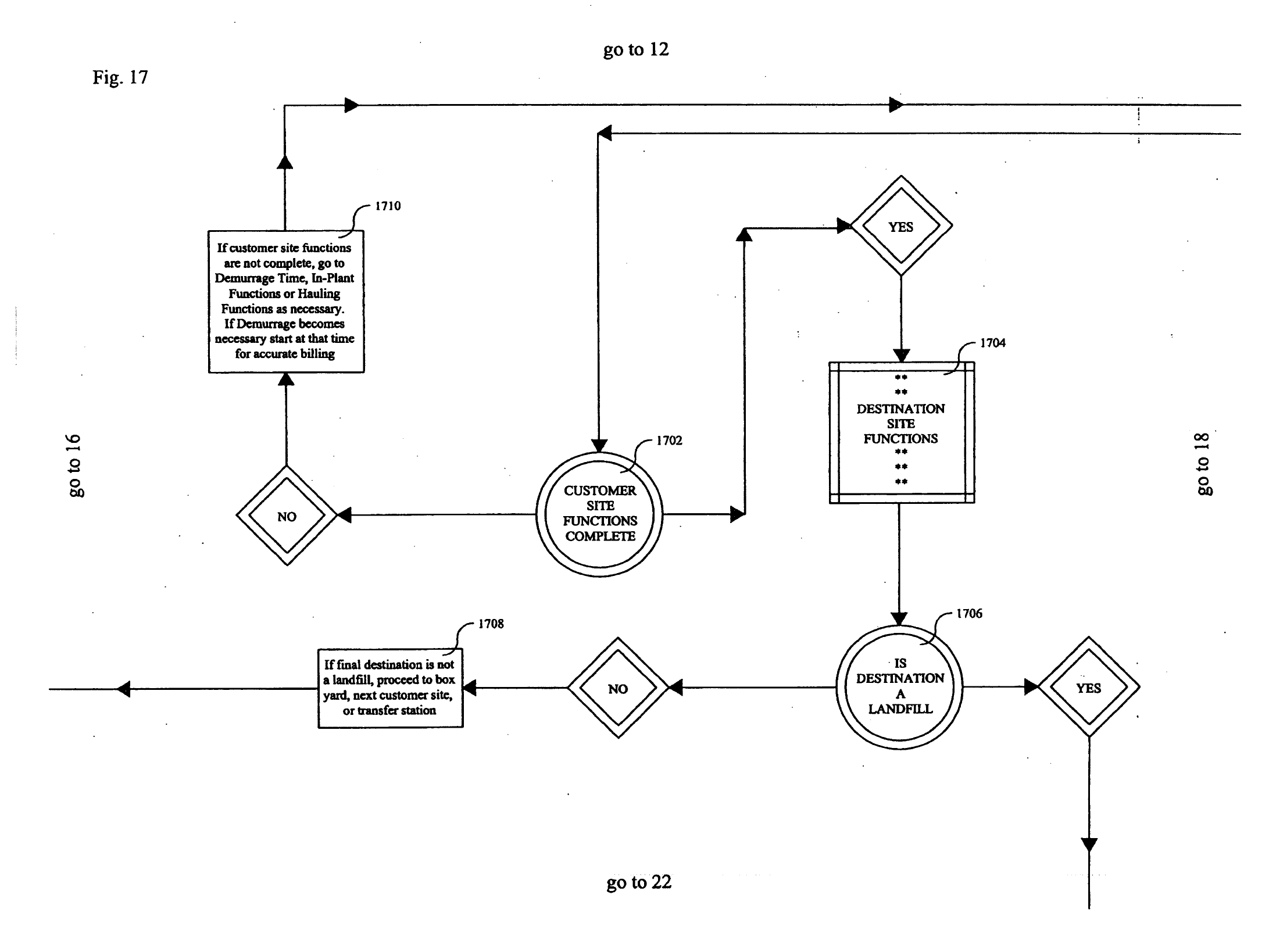

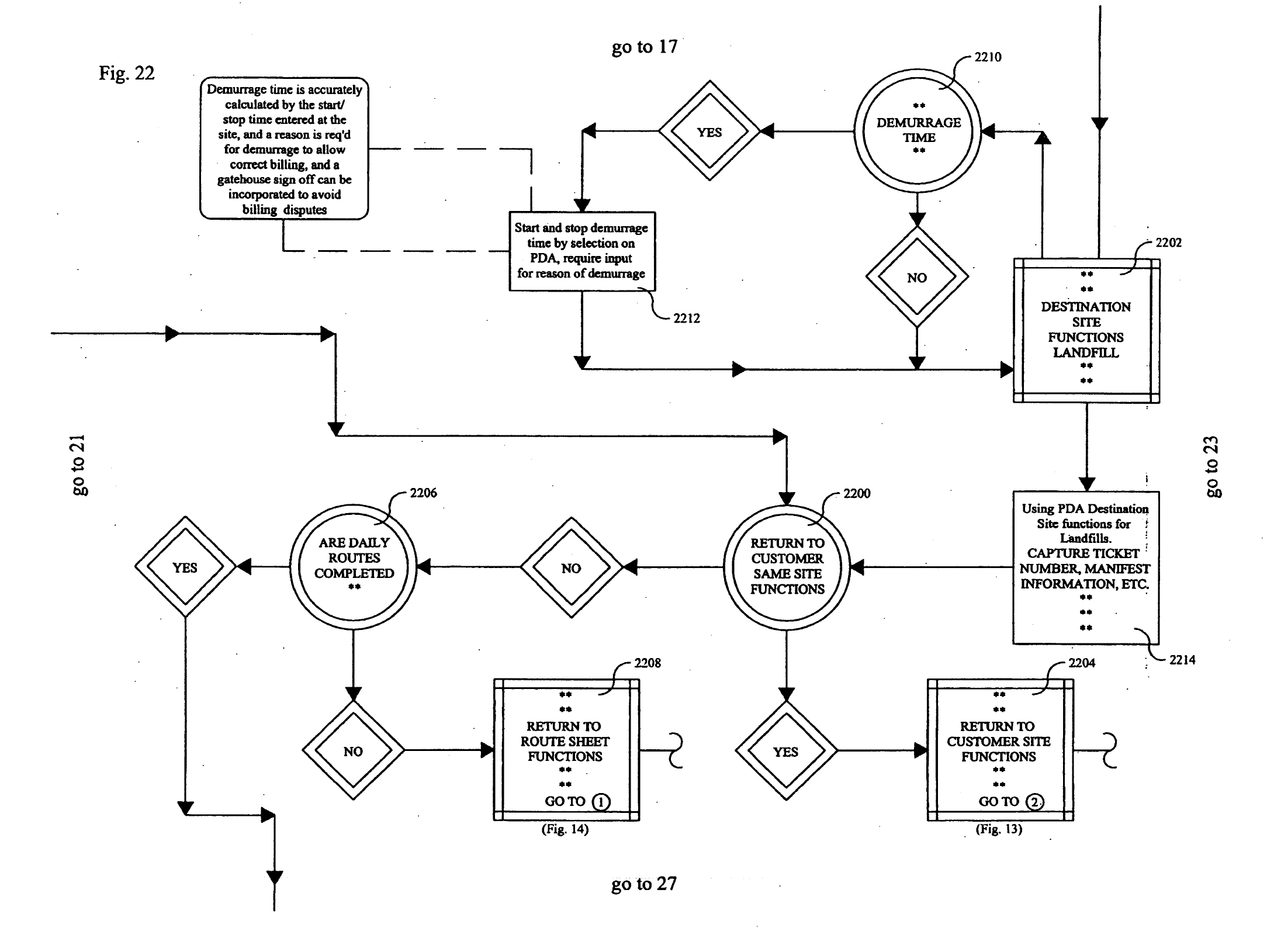

FIG. 17 is a schematic diagram of a portion of the program relating to destination site functions and some of the flow lines are linked to FIG. 13. If the customer site functions are not complete, the program can return to the customer site functions 1302 in FIG. 13 for completion. The completion can include, for example, calculation of demurrage time which may occur from delays, customer instructions, destination sites, plant hauling functions, and other features. In general, if the customer site functions are incomplete, the program can be directed in block 1710 to the customer site functions 1302, referenced in FIG. 13, for completion. If the customer site functions are complete, the program is directed to a portion of the program termed the “destination sites functions” 1704. Upon entering the destination site functions 1704 portion of the program, a determination 1706 is made as to whether the destination is a landfill. If the destination is a landfill, the program can proceed to a program portion of destination site functions landfill 2202, shown in FIG. 22. If the destination is not a landfill, the program can be directed, in block 1708, to the destination site functions for non-landfill destinations 1602, referenced in FIG. 16. Such considerations can include for example, proceeding to a box yard, a next customer site, or a transfer station, described herein.

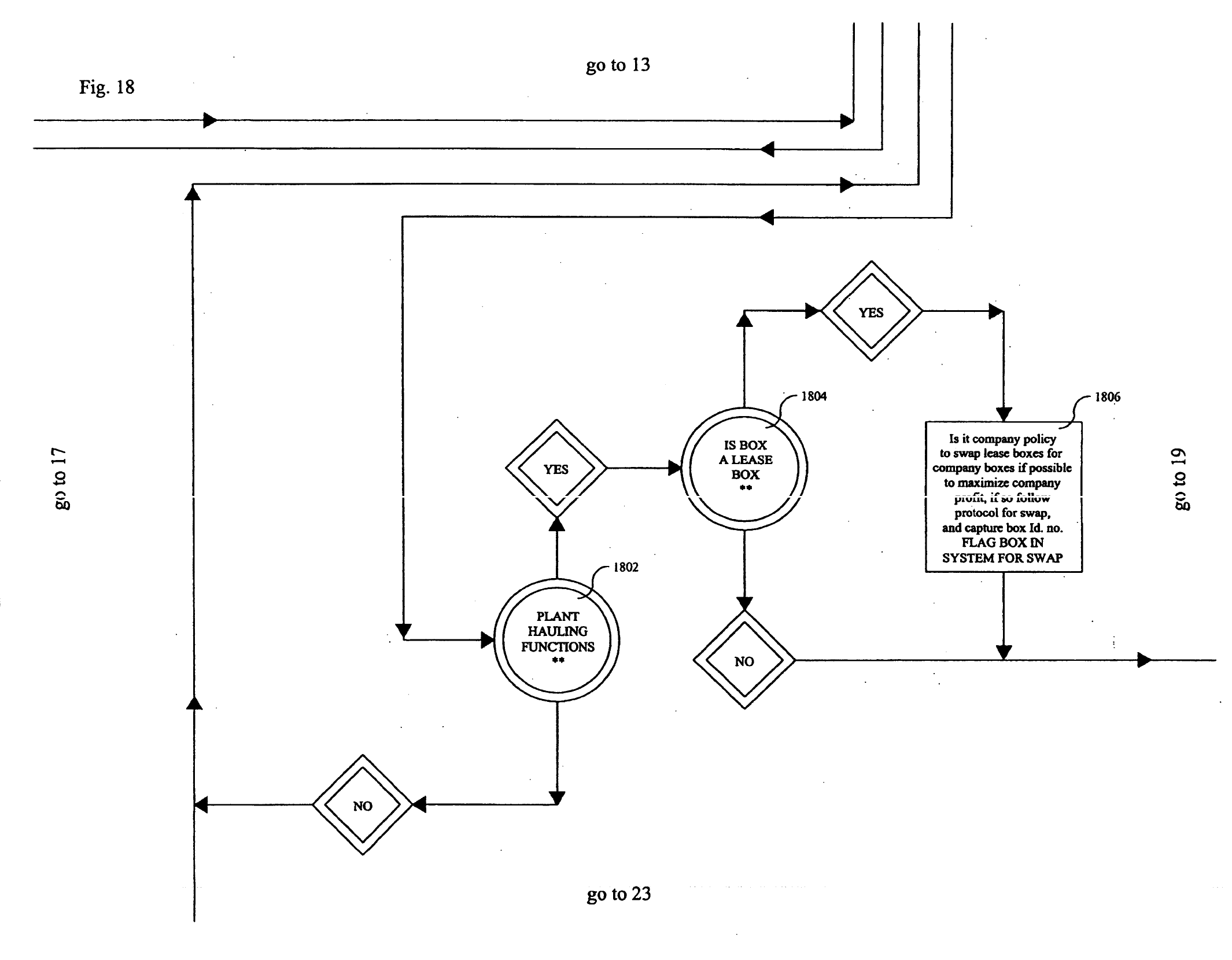

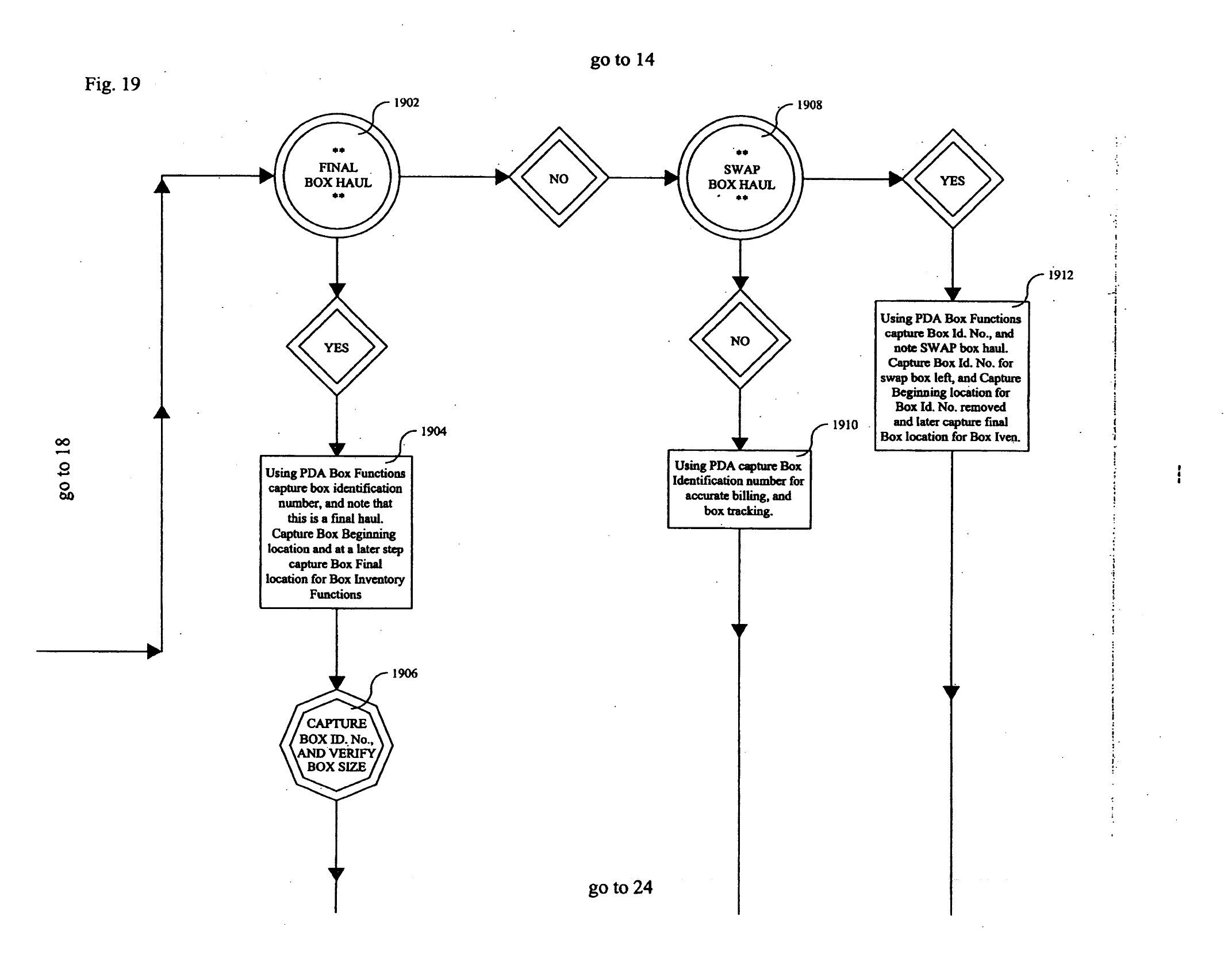

FIG. 18 is a schematic diagram relating to plant hauling functions. In general, the customer site functions 1302, shown in FIG. 13, can include plant hauling functions, shown in FIG. 18. In one embodiment, the program can provide for a determination 1802 as to whether there are specific plant hauling functions at a particular customer site. If there are no specific plant hauling functions, the program can proceed or otherwise be directed to the customer site functions 1302, shown in FIG. 13. If there are plant hauling functions, in at least one embodiment, a determination 1804 can be made as whether the box is a lease box. If the box is a lease box, a determination 1806 can be made as to whether the particular customer or waste hauler has a policy to exchange lease boxes for one or more waste hauler's boxes. If such a policy exists, the operator can follow the protocol for the exchange and capture a box identification number. Further, the operator or program can flag the box in the system regarding the exchange. The program is then directed to the program portions, referenced in FIG. 19.

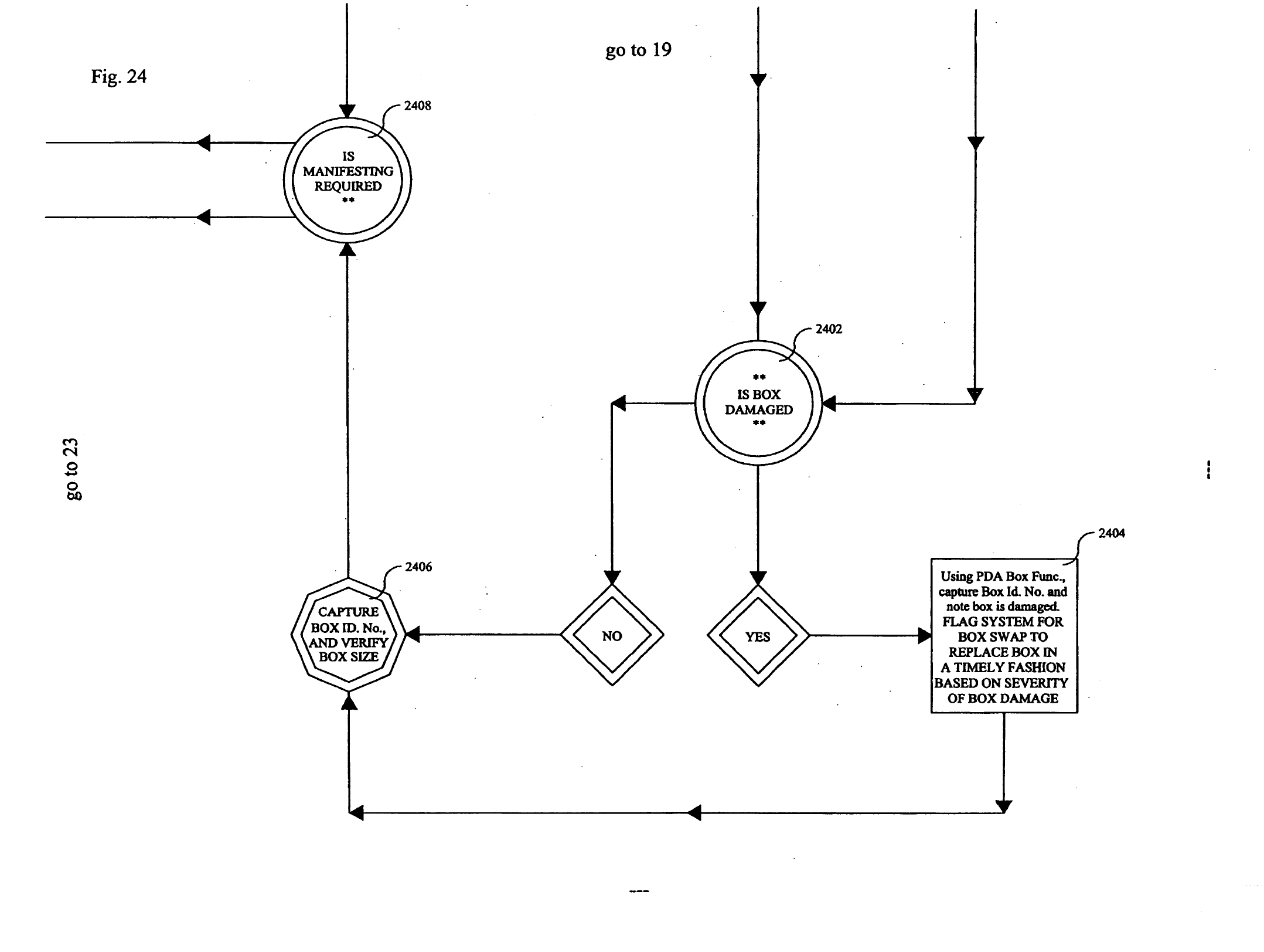

FIG. 19 is a schematic diagram of a portion of the program related to box hauls. Continuing from FIG. 18, a further determination 1902 is made as to whether the box haul is a final box haul. If the box haul is final, the portable unit can capture a box identification number, and note that the haul is a final haul in block 1904. The information can be used to determine a box's beginning location and final location to assist in the box inventory functions of the waste management system. Further, block 1906 can represent a push button or other activation by the operator or through automatic input to capture the box identification and verify the box size. The program continues to FIG. 24, where a determination of manifesting is made.

Returning to FIG. 19, if the box haul is not the final box haul, then a determination 1908 is made as to whether to exchange the hauled box. For example, the operator may haul an empty box, leave the box, and take a full box. If the box is not to be exchanged, the portable unit can capture the box identification number, if not already captured, for accurate billing and box tracking purposes, in block 1910. If the hauled box is to be exchanged, the portable unit can capture the box identification number, if not already obtained, and note that the hauled box is to be exchanged. In block 1912, the information can also capture the box identification number for the exchange box that is left on site, and there after capture of the beginning location of the removed box and its identification number, and subsequently capture the final box location for box inventory purposes.

Digressing from the order of figures, attention is now directed to FIG. 24 to complete the portion of the box description of FIG. 19.

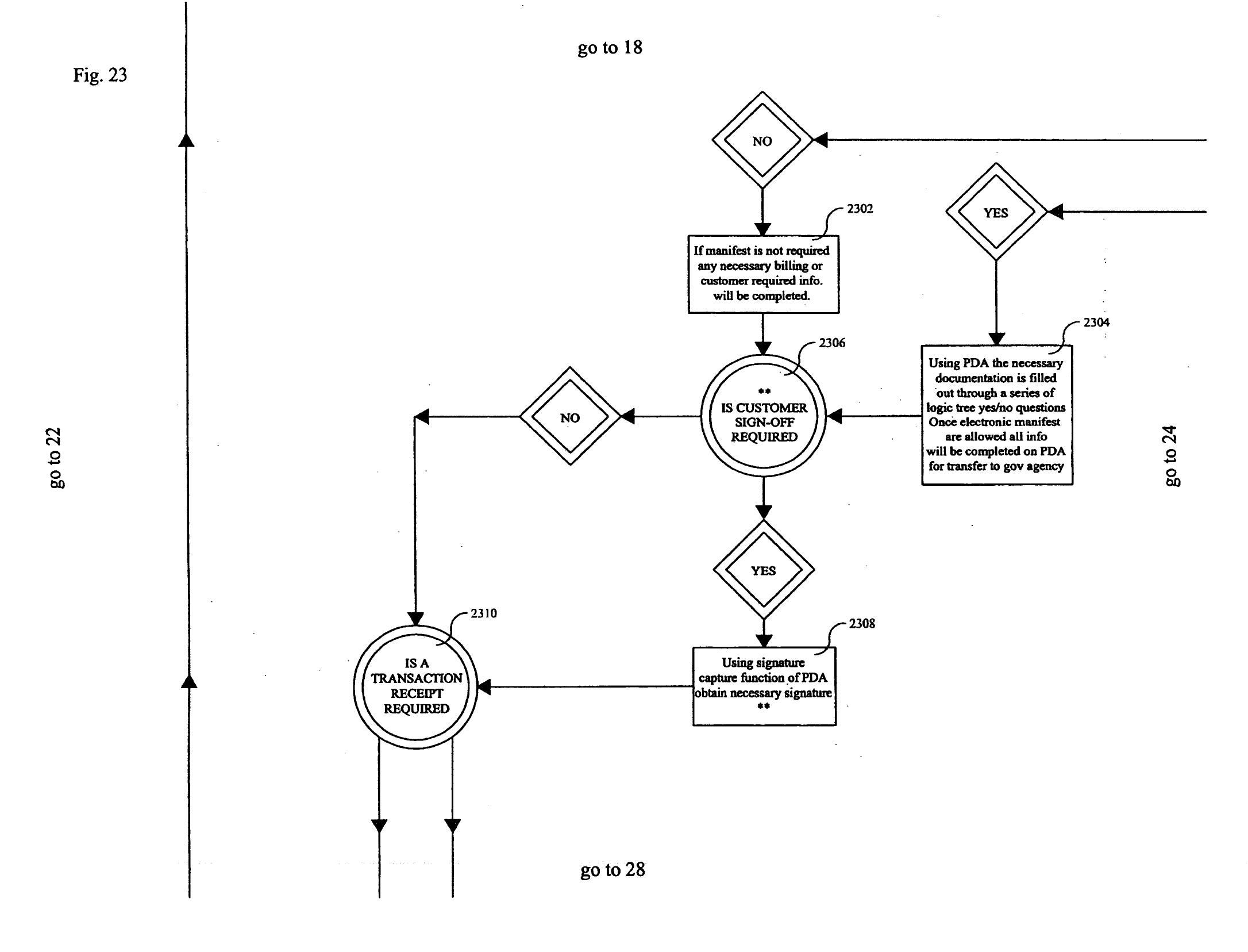

FIG. 24 is a schematic diagram of a portion of the program related to box damage assessments. Whether the exchange box is hauled or left, a determination 2402 can be made as to whether the box is damaged. If the box is damaged, the portable unit can capture the box identification, if not already captured, and note that the box is damaged. The operator can flag the information, based upon the severity of the box damaged, to exchange the box with a replacement box in block 2404 in a timely fashion. If the box is not damaged, the system captures the box identification in block 2406 and verifies the box size to aid in tracking. A further determination 2408 can be made as to whether manifesting is required. The sequences of “yes” and “no” will be described in more detail in reference to FIG. 23.

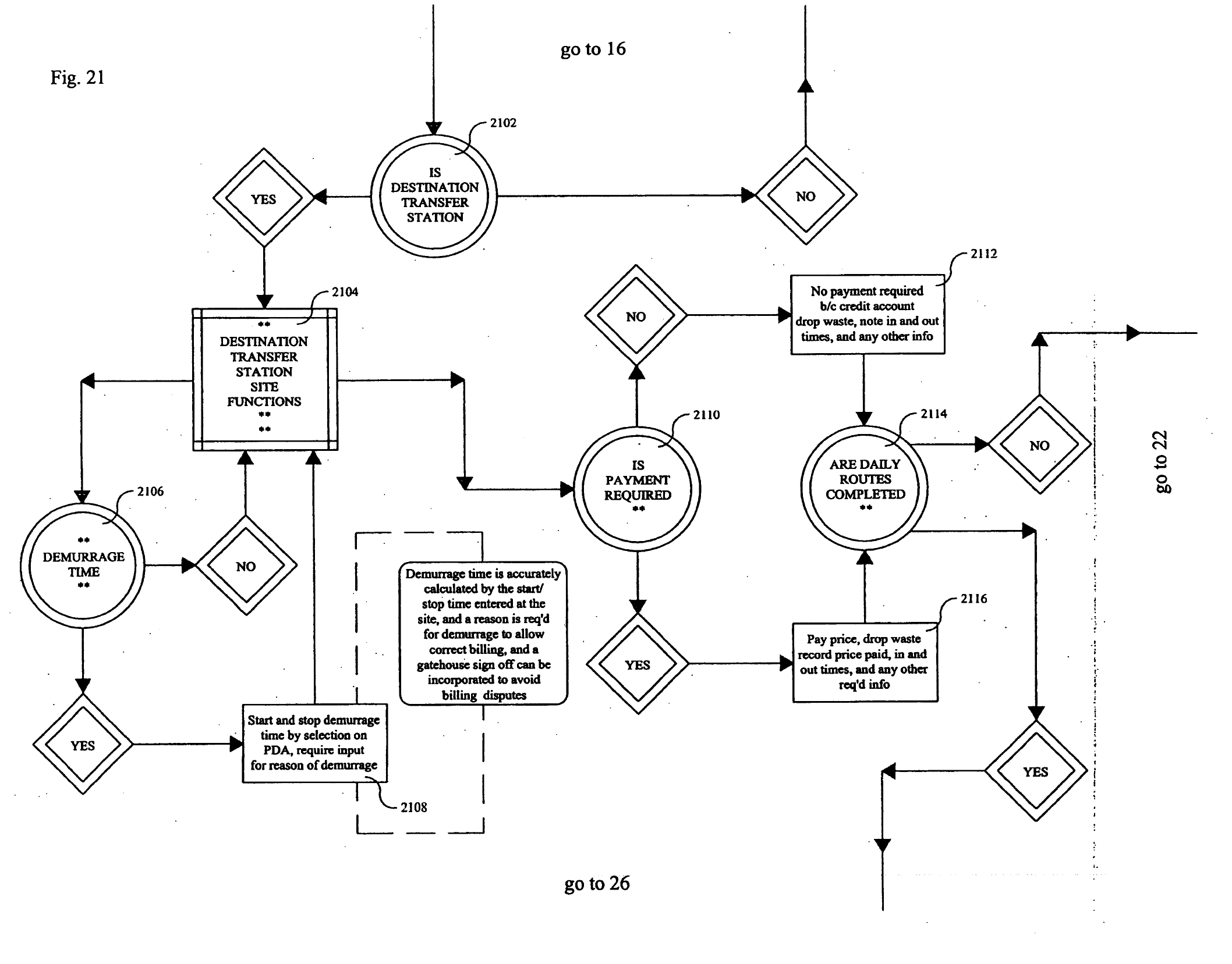

FIG. 21 is a schematic diagram of a portion of the program relating to destination transfer station site functions. In general, the functions shown in FIG. 21 relate to the destination site functions for non-landfill destinations 1602, shown in FIG. 16, in at least one embodiment. A determination 2102 is made as to whether the destination is a transfer station. If the destination is not a transfer station, the program returns to the destination site functions for non-landfill destinations 1602, shown in FIG. 16. If the destination is a transfer station, the program enters the destination transfer station site functions 2104. In at least one embodiment, the destination transfer station site functions 2104 can include a determination 2106 of whether the demurrage time is appropriate. If no demurrage time is appropriate, the destination returns to the destination transfer station site functions 2104. If there is demurrage time, the program in block 2108 can request input from the operator or automatically calculate demurrage time based on selection criteria in the portable unit. Further, the portable unit can include a preprogrammed query of the reason for demurrage. In general, the demurrage time can be accurately calculated by the start and stop time entered at the customer facility and the reason for the demurrage. This entry can facilitate correct billing, and a signature by the personnel at the transfer station, such as at a gatehouse, can be captured. The program can link back to the destination transfer station site functions 2104.

The destination transfer site functions 2104 can also include a determination 2110 of whether payment is required at the transfer station. If no payment is required, for example, when a credit account has been established or other arrangements made, then the operator can simply leave the waste at the transfer station, note in and out times, and make appropriate entries into the portable unit in block 2112, as may be requested or desirable. If payment is required, the payment can be made and recorded in the portable unit with in and out times and other information as may be appropriate in block 2116.

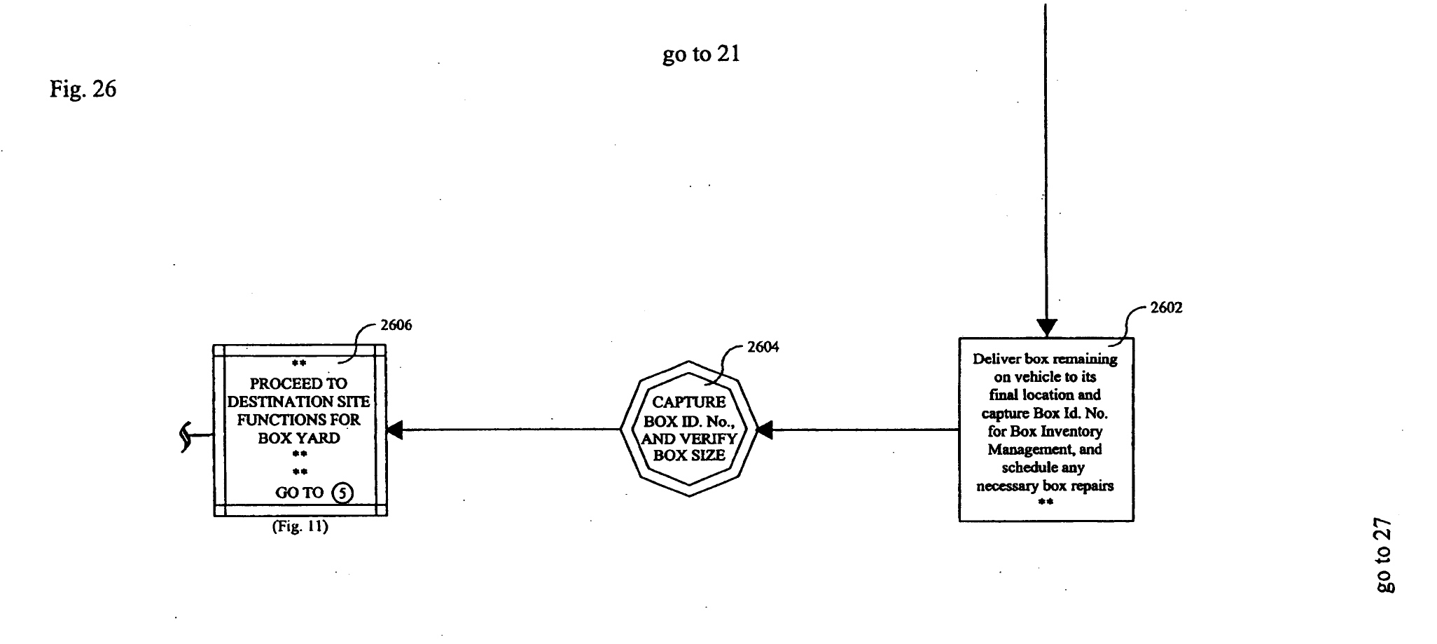

After leaving the waste, a determination 2114 can be made as to whether the daily routes are completed. If the daily routes are not completed, the system can link to a further determination 2200, shown in FIG. 22, as to whether to return to the customer same site functions portions of the program in FIG. 13. If daily routes are completed, the operator can deliver a box remaining on the vehicle, if any, to its final destination, capture the box identification number for box inventory management, and schedule any necessary box repairs in block 2602, referenced in FIG. 26.

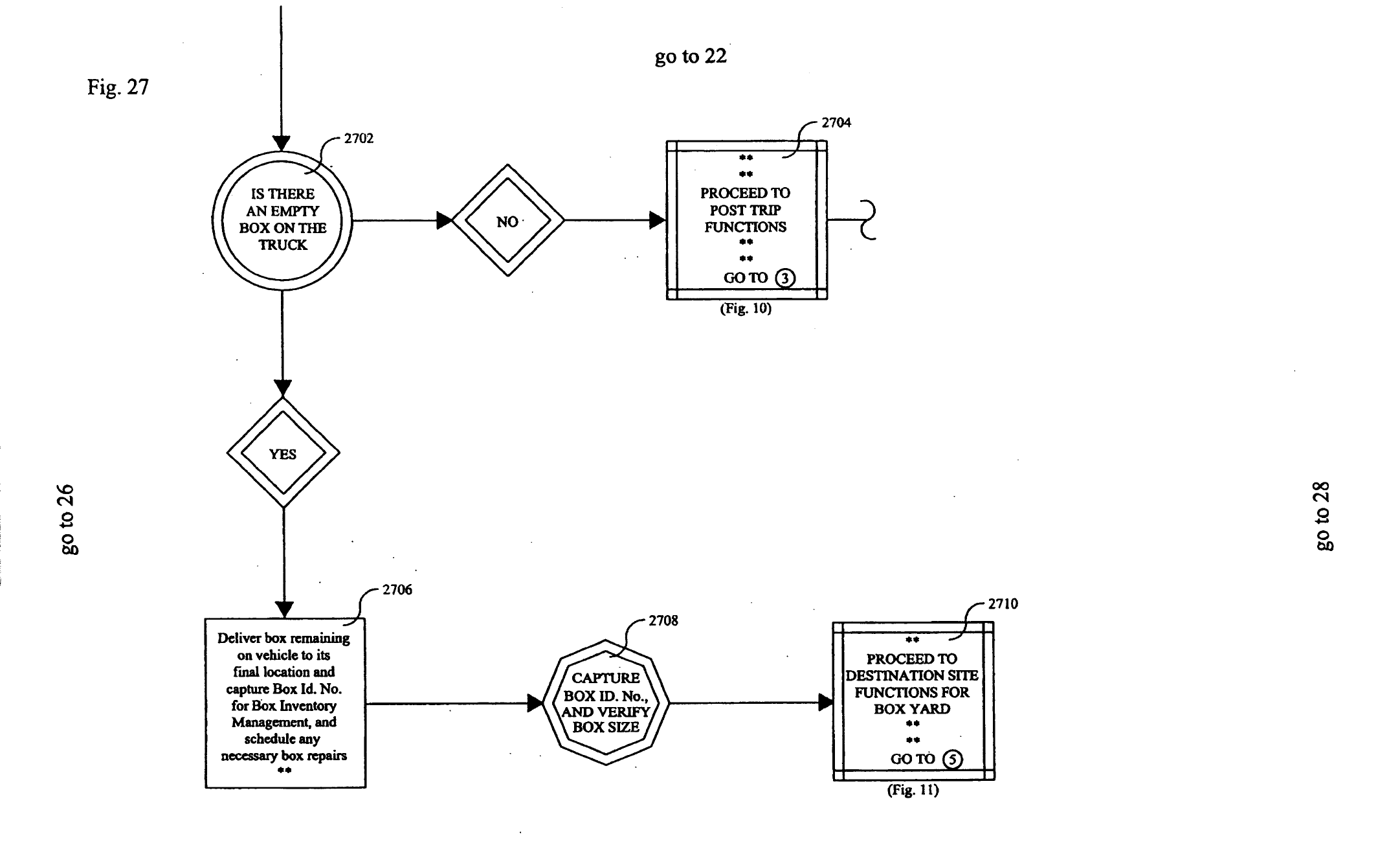

FIG. 22 is a schematic diagram of a portion of the program related to destination site functions and customer site functions. As noted in FIG. 21, if the daily routes are not completed in determination 2114, a determination 2200 can be made whether to return to customer same site functions, referenced in FIG. 13. If the answer is yes, the program returns in block 2204 to the customer same site functions 1302, shown in FIG. 13. If the operator does not choose to return to the customer same site functions, a determination 2206 is made as to whether the daily routes are completed. If they are not completed, the program returns in block 2208 to the route sheet functions 1402, shown in FIG. 14. If the daily routes are completed, the program is directed to a determination 2702 as to whether there is an empty box on the vehicle, referenced in FIG. 27.

Referencing for the moment FIG. 17, a determination 1706 is made as to whether the destination is a landfill. If the destination is a landfill, the flow line enters from the top on FIG. 22 to the destination site functions landfill 2202. The destination site functions landfill 2202 includes a determination 2210 as to whether demurrage time is appropriate. If demurrage is inappropriate, the program returns to the destination site functions landfill 2202. If demurrage time is appropriate, the demurrage can be determined by operator selection on the portable unit in block 2212, or by automatic calculation through programming on the portable unit. Additionally, the portable unit can require input regarding the reason for the demurrage and a signature by an authorized person at the site. The destination site functions landfill 2202 can include features such as capturing the ticket number, manifest information, box identification, and other aspects in noted in block 2214 that can be uploaded to the database, referenced in FIG. 1. The program can link to the determination 2200, described above, as to whether to return to the customer same site functions.

FIG. 23 is a schematic diagram relating to a portion of the program for manifests. Referring briefly to FIG. 24 described herein, one portion of the program requests a determination 2408 as to whether a manifest is required. FIG. 23 further explains the logic flow path. If a manifest is not required, the flow line entering the top right of FIG. 23 illustrates that any necessary billing or customer information can be input into the portable unit in block 2302. If a manifest is required, the flow line entering the right center portion of FIG. 23 to block 2304 illustrates that the portable unit can be used to input any desired or necessary documentation as may be appropriate to complete a manifest. For example, a series of preprogrammed queries can be made to the operator or other personnel that step through a variety of “yes” and “no” questions, quantitative and qualitative input, or other types of input. Further, the manifest can be provided from the customer via an electronic transfer, card swipe, IR input, scan, and other input methods. This feature may be especially advantageous when governmental agencies allow electronic manifests to be submitted. In such cases, the portable unit can upload the information to the database, described in FIG. 1, and an electronic manifest is submitted to the governmental agency for compliance with environmental regulations.

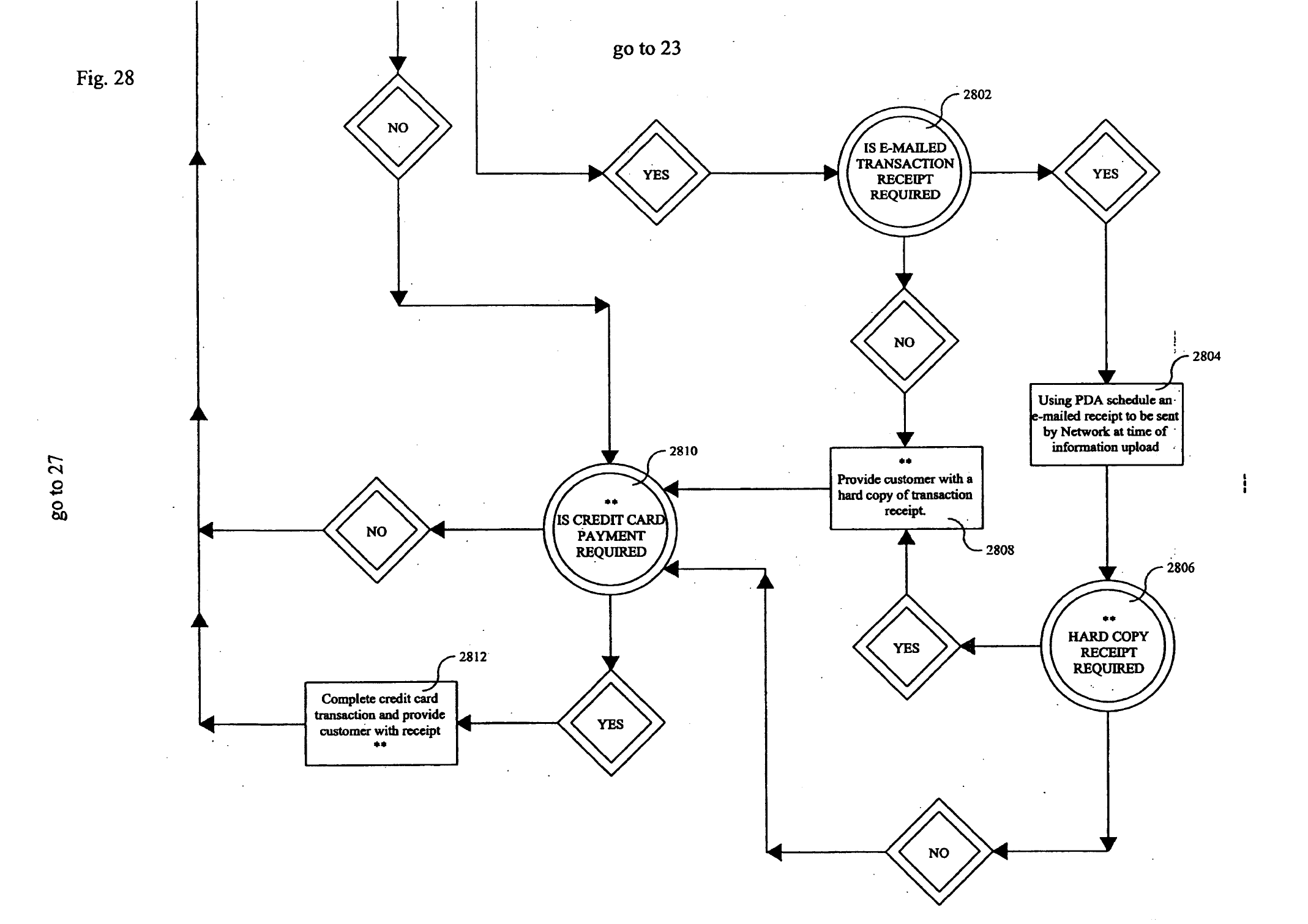

In at least one embodiment, regardless of whether an electronic manifest is required, a determination 2306 is made as to whether a customer sign off is required. Generally, the portable unit may default to request a customer sign off. In other cases, the customer itself may dictate the procedure. Thus, the determination 2306 can be either customer-specific or defaulted to a particular requirement. If a customer sign off is required, as shown in block 2308, the portable unit can be used to capture the signature of an authorized person at the facility. If a customer sign off is not required, a further determination 2310 can be made as to whether there is a transaction receipt required. Further details of the transaction receipt are described in reference to FIG. 28.

FIG. 26 is schematic diagram of a portion of the program relating to delivery of the box, file destination, and a possible pick up of an empty box. Referring briefly to FIG. 21, a determination 2114 is made as to whether the daily routes are completed. If the answer is yes, the flow lines enter the top of FIG. 26 to a block 2602. Block 2602 represents a portion of the system and method that allows the operator to deliver the box remaining on a vehicle to its final destination, capture the box identification for box inventory management, and schedule any necessary box repairs. Block 2602 is linked to block 2604, that represents the input of the box identification and verification of the box size. Such input can be accomplished manually by the operator, or a by a variety of other input means, such as scanning, electronic transducers, and other methods described herein.

In at least one embodiment, after box identification, the program can proceed in block 2606 to the destination site functions for the box yard 1104, shown in FIG. 11, where decisions such as the final destination for the day, pick up of new empty boxes, and other decisions are made.

FIG. 27 is a schematic diagram of a portion of the flow chart that relates to decisions after the daily routes are completed. Referring briefly to FIG. 22, a determination 2206 is made as to whether the daily routes are completed. If the answer is yes, a flow line enters the top of FIG. 27. A determination 2702 is made as to whether there is an empty box on the truck or other vehicle that the operator is using. If the answer is no, the program proceeds in block 2704 to the post trip functions 1004, shown in FIG. 10. If the answer is yes, the operator can deliver the box remaining on the vehicle to its final location, as shown in block 2706, capture the box identification for box inventory management, and schedule any necessary box repairs. Block 2706 is linked to block 2708. Block 2708 represents input of the box identification number and verification of size, if desired. The program can proceed in block 2710 to the destination site functions for box yard 1104, shown in FIG. 11.

FIG. 28 is a schematic diagram of a portion of the program relating to transaction receipts and customer payments. Referring briefly to FIG. 23, a determination 2310 is made as to whether a transaction receipt is required. The results of the determination are represented by the flow lines entering the top of FIG. 28. If a transaction receipt is required, a further determination 2802 is made as to whether an electronic transaction receipt, such as via email or other electronic communications, is required. If no electronic transaction receipt is required, the operator can provide the customer in block 2808 a hard copy of the transaction receipt as an output from the portable unit. If one is required, in at least one embodiment, the portable unit can be used to either send the receipt or to schedule sending the receipt at a subsequent time in block 2804. For example, the scheduled receipt can be sent after upload of the information to the base unit. Some customers may also request a hard copy of the transaction receipt. Therefore, a determination 2806 can also be made as to whether a hard copy receipt is required. If a hard copy is also needed, the operator and/or portable unit can provide a hard copy of the transaction receipt as an output from the portable unit. If the answer is no, the system can also made a determination 2810 as to whether a credit card payment is required, discussed below.

Returning to the determination 2310 in FIG. 23, if no transaction receipt is required, or if a transaction receipt was provided by the determination 2806, a further determination 2810 is made as to whether a credit card payment is required. If no credit card payment is required, the system can return through the flow line represented to the left of FIGS. 18, 23, 28 into FIG. 13. If a credit card payment is required, the operator can complete the credit card transaction in block 2812 and provide the customer with the receipt. The program can return to the customer site functions 1302, referenced in FIG. 13, for further instructions as needed or desired.

While the foregoing is directed to various embodiments of the present invention, other and further embodiments may be devised without departing from the basic scope thereof. Other embodiments within the scope of the claims herein will be apparent to one skilled in the art from consideration of the specification and practice of the invention as disclosed herein. For example, various other flow paths of various orders and options can be included to provide the functionality described herein and claimed in the claims. It is intended that the specification, together with the example, be considered exemplary only, with the scope and spirit of the invention being indicated by the claims which follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the Figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant.

1. A waste management system, comprising:
a. a waste management electronic base system having a memory, processor, an input element, and an output element, the base system adapted to process waste management data for tracking a location of a waste storage unit, billing a customer associated with a waste removal, and paying personnel for services associated with the waste removal; and
b. an electronic portable unit having a memory, processor, an input element, and an output element, the portable unit adapted to allow an operator during a waste removal to use the portable unit and to allow onsite input at a customer facility from preprogrammed queries regarding the waste removal and further being adapted to generate an output of the data to the base system for processing.

2. The system of claim 1, further comprising a waste removal vehicle and a waste storage unit selectively coupled with the waste removal vehicle.

3. The system of claim 1, wherein the waste comprises industrial waste and the system is adapted to comply with a manifest associated with the industrial waste.

4. The system of claim 1, wherein the base system generates a manifest based on information from a generator of waste obtained from the portable unit.

5. The system of claim 1, wherein the onsite input allows operator input, automatic input, or a combination thereof.

6. The system of claim 1, wherein the onsite input comprises a scanner, keyboard, touch screen, wireless interface, voice recognition interpreter, preprogrammed cards, or a combination thereof.

7. The system of claim 1, wherein the portable unit output comprises a wireless interface with the base system.

8. The system of claim 1, wherein the system further comprises multiple portable units for multiple operators during their respective routes for multiple waste removals.

9. The system of claim 1, wherein the base system is adapted to provide download information to the portable unit, the information containing instructions to the operator for a route of the operator.

10. The system of claim 1, wherein the portable unit is adapted to require predetermined operator input for a first operation to release the operator to perform a next operation.

11. The system of claim 1, wherein the portable unit is adapted to output an invoice for a customer at the customer site relative to the waste removal.

12. A method of managing waste removal, comprising:
a. using a waste management electronic base system having a memory, processor, an input element, and an output element, to process waste management data, comprising:
i. tracking a location of a waste storage unit;
ii. billing a customer associated with a waste removal; and
iii. paying personnel for services associated with the waste removal; and
b. using an electronic portable unit having a memory, processor, an input element, and an output element, to gather onsite data for the base system, comprising:
i. allowing an operator to input onsite data at a customer facility into the portable unit from preprogrammed queries regarding the waste removal; and
ii. generating an output of the data to the base system for processing.

13. The method of claim 12, further comprising downloading information from the base system to the portable unit, the information containing instructions to the operator for a route of the operator.

14. The method of claim 12, further comprising requiring predetermined operator input for a first operation to release the operator to perform a next operation.

15. The method of claim 12, further comprising scanning input information into the portable unit regarding a waste storage unit.

16. The method of claim 12, further comprising selectively coupling a waste storage unit with the waste removal vehicle.

17. The method of claim 12, wherein the waste comprises an industrial waste and further comprising generating a manifest associated with the industrial waste.

18. The method of claim 12, further comprising accepting an electronic manifest into the portable unit.

19. The method of claim 12, further comprising generating an invoice from the portable unit for a customer at the customer site relative to the waste removal.

20. The method of claim 12, further comprising providing the onsite input with operator input, automatic input, or a combination thereof.

21. The method of claim 12, further comprising providing the onsite input by a scanner, keyboard, touch screen, wireless interface, voice recognition interpreter, preprogrammed cards, or a combination thereof.

22. The method of claim 12, further comprising sharing information between the portable unit and the base system through a wireless interface.

23. The method of claim 12, further comprising requiring a predetermined operator input for a first operation before releasing the operator to perform a next operation.
